(19) United States
(12) Patent Application Publication
(10) Pub. No.: US 2024/0399721 A1
(43) Pub. Date: Dec. 5, 2024

(54) MULTILAYER STRUCTURE, AND METHOD FOR SEPARATING SAME AND METHOD FOR RECYCLING SAME

(71) Applicant: Kuraray Co., Ltd., Okayama (JP)

(72) Inventors: Satoshi ISHIUCHI, Tokyo (JP); Kentaro YOSHIDA, Tokyo (JP)

(73) Assignee: Kuraray Co., Ltd., Okayama (JP)

(21) Appl. No.: 18/694,287

(22) PCT Filed: Sep. 22, 2022
(86) PCT No.: PCT/JP2022/035402

§ 371 Date: Mar. 21, 2024

(30) Foreign Application Priority Data
Sep. 22, 2021 (JP) 2021-153885

(51) Int. Cl. B32B 27/08; B32B 7/02; B32B 27/22; B32B 27/30; B32B 27/32; B32B 27/34; B32B 27/36; B32B 43/00

(52) U.S. Cl. CPC B32B 27/08; B32B 7/02; B32B 27/22; B32B 27/306; B32B 27/32; B32B 27/34; B32B 27/36; B32B 43/006; B32B 2307/7166; B32B 2307/72; B32B 2307/7244; B32B 2307/748; B32B 2307/75; B32B 2553/00

(57) ABSTRACT

Present disclosure provides a multilayer structure including a layer structure (X) and a layer structure (Y) which are laminated via a water-soluble layer (A).

### TECHNICAL FIELD

The present invention relates to: a multilayer structure that is superior in adhesiveness under high humidity and an oxygen barrier property, and in peelability in a separation step; and a method for separating the same and a method for recycling the same.

### BACKGROUND ART

As materials for plastic packaging involving food wrapping, a variety of materials having various functions such as mechanical properties, heat resistance, gas barrier properties, and heat sealing properties are laminated for use. Various types of polyolefins are extensively used, such as e.g.: polyamides in order to enhance mechanical properties; polyesters in order to enhance heat resistance; ethylene-vinyl alcohol copolymers and polyvinylidene chloride in order to enhance gas barrier properties; and polyethylenes and polypropylenes in order to enhance heat sealing properties.

Furthermore, in recent years, owing to environmental problems and waste problems, demands for post-consumer recycling, as generally referred to (hereinafter, may be merely abbreviated to “recycling”), in which packaging materials consumed in the market are collected and recovered as resources, have increased worldwide. In the recycling, steps of: crushing and cutting collected packaging materials; followed by, as needed, subjecting to separation, fractionation and washing; melt molding using an extruder; and performing repelletization to give a recycled resin are generally employed. By using pellets thus obtained, a broad range of molded products are produced.

As the separation/fractionation method, for example, Patent Document 1 discloses a method for separation including bringing waste into contact with an aqueous liquid selected such that a part of the waste is sedimented to obtain a selected matter containing 90% by weight or more materials (waste) having a specific gravity falling within a previously selected range. Moreover, Nonpatent Document 1 discloses that in mutual separation of common plastics, when a separative floatation-sedimentation method is employed, separability is improved by adding a wetting-agent to eliminate hydrophobicity of the plastic surface.

In addition, Patent Document 2 discloses that in a wrapping film in which at least two substrate layers consisting of materials of differing type are laminated, each substrate layer can be readily separated by allowing dissolution of an intervening layer which is soluble in a solvent and provided between the substrate layers, by immersion in the solvent.

### PRIOR ART DOCUMENTS

### Patent Documents

Patent Document 1: Japanese Unexamined Patent Application (Translation of PCT Application), Publication No. 2017-515676
Patent Document 2: PCT International Publication No. 2020/166685

### Nonpatent Documents

Nonpatent Document 1: Journal of the Mining and Metallurgical Institute of Japan No. 92, Vol. 1064 pp. 675-679

### SUMMARY OF THE INVENTION

### Problems to Be Solved by the Invention

As described above, a variety of materials are used as materials for plastic packaging involving food wrapping, and many of them are combinations of materials which are difficult directly recycle. For example, many polyesters such as polyethylene terephthalate have high melting points, thereby making it difficult to recycle these polyesters by mixing with other material(s) commonly used as a packaging material. Furthermore, it is difficult to recycle chlorine resins such as polyvinylidene chloride by mixing with other material(s) commonly used as a packaging material, owing to influences on processing facilities, and concerns regarding deterioration of quality of the recycled resin.

Thus, it is necessary to allow a layer, which is soluble in a solvent, to be interposed such that different types of materials of used as packaging materials can be separated from one another. However, in the multilayer structure disclosed in Patent Document 2, interlayer adhesiveness under high humidity may be insufficient, or peelability in a solution during stirring may be insufficient. In a separation step accompanied by dissolution of a layer that is soluble in a solvent, easy separation between different types of materials is important, whereas high solubility in a solvent results in insufficient adhesiveness under high humidity; therefore, it is difficult to exhibit both the interlayer adhesiveness under high humidity and peelability in the separation step.

The present invention was made in order to solve the problems described above, and an object of the invention is to provide: a multilayer structure being superior in an oxygen barrier property, and also superior in interlayer adhesiveness under high humidity, and peelability in the separation step; and a method for separating the same. Moreover, further provided in terms of an object of the present invention is a method for recycling which includes independently melt molding each of substances thus separated.

### Means for Solving the Problems

The foregoing problems can be solved by providing any of the following:
(1) A multilayer structure including a layer structure (X) and a layer structure (Y) which are laminated via a water-soluble layer (A), wherein
   the layer structure (X) includes a substrate layer (B) containing at least one selected from the group consisting of a thermoplastic resin and a metal (hereinafter, may be abbreviated to “substrate layer (B)”),
   the layer structure (Y) includes a polyolefin layer (D) (hereinafter, may be abbreviated to “PO layer (D)”) or a paper layer,
   a density difference (X-Y) between the layer structure (X) and the layer structure (Y) is 0.2 g/cm³ or more,
   an oxygen transmission rate (OTR) of at least one of the layer structure (X) and the layer structure (Y) measured in accordance with JIS K7126-2 (equal pressure method; 2006) at 20° C. and 65% RH is 20 cc/(m²·day·atm) or less, and
   the water-soluble layer (A) contains a hydroxyl group-containing resin (a1) and an alkali metal ion (a2), and a content of the alkali metal ion (a2) in the water-soluble layer (A) is 10 ppm or more and 2,000 ppm or less;
(2) The multilayer structure according to (1), wherein a density of the layer structure (X) is 1.0 g/cm³ or more, and a density of the layer structure (Y) is 1.0 g/cm³ or less;
(3) The multilayer structure according to (1) or (2), wherein the hydroxyl group-containing resin (a1) is a polyvinyl alcohol (hereinafter, may be abbreviated to “PVA”);
(4) The multilayer structure according to (3), wherein a viscosity-average degree of polymerization of the PVA is 400 or more and 2,000 or less;
(5) The multilayer structure according to (3) or (4), wherein a degree of saponification of the PVA is 70 mol % or more and 95 mol % or less;
(6) The multilayer structure according to any of (3) to (5), wherein a sum of contents of a vinyl alcohol unit and a vinyl ester unit in total monomer units of the PVA is 95 mol % or more;
(7) The multilayer structure according to any of (1) to (6), wherein the water-soluble layer (A) further contains a plasticizer (a3) which consists of at least one selected from the group consisting of glycerin, polyethylene glycol, polypropylene glycol, polyglycerin, mannitol, sorbitol, and pentacrythritol (hereinafter, may be abbreviated to “plasticizer (a3)”);
(8) The multilayer structure according to any of (1) to (7), wherein the substrate layer (B) contains a polyester resin as a principal component;
(9) The multilayer structure according to any of (1) to (8), wherein the layer structure (X) includes an adhesive layer (C) being in direct contact with the water-soluble layer (A);
(10) The multilayer structure according to any of (1) to (9), wherein a ratio of a mass of the PO layer (D) to a total mass of the layer structure (Y) is 0.90 or more;
(11) The multilayer structure according to any of (1) to (10), wherein the layer structure (Y) includes a barrier layer (E) containing, as a principal component, at least one selected from the group consisting of a polyamide (hereinafter, may be abbreviated to “PA”) and an ethylene-vinyl alcohol copolymer (hereinafter, may be abbreviated to “EVOH”) (hereinafter, may be abbreviated to “barrier layer (E)”);
(12) The multilayer structure according to (11), wherein the barrier layer (E) contains the EVOH as a principal component;
(13) The multilayer structure according to any of (1) to (12), wherein at least one of the layers is subjected to printing;
(14) A method for separating a multilayer structure, the method including dissolving a part or all of the water-soluble layer (A) by bringing the multilayer structure according to any of (1) to (13) into contact with water (W) having a temperature of 20° C. to 95° C., wherein
   in the dissolving, the layer structure (X) is sedimented and the layer structure (Y) is floated, in the water (W);
(15) A method for recycling a multilayer structure, the method including independently melt molding each of the layer structure (X) and the layer structure (Y), each being collected by the method for separating a multilayer structure according to (14).

### Effects of the Invention

The multilayer structure of the present invention is superior in an oxygen barrier property, and enables providing a multilayer structure and a method for separating the same, each being superior in interlayer adhesiveness under high humidity and peelability in the separation step. In addition, providing a method for recycling which includes independently melt molding each of substances thus separated is enabled.

### DESCRIPTION OF EMBODIMENTS

As referred to herein, a “layer structure” means a structure which may be either monolayered or multilayered. Furthermore, “comprising/containing as a principal component” as referred to means that the content is more than 50% by mass. Also, “water soluble” means being soluble in pure water having a temperature of 80° C.

The multilayer structure of the present invention is a multilayer structure including a layer structure (X) and a layer structure (Y) which are laminated via a water-soluble layer (A), wherein the layer structure (X) includes a substrate layer (B) containing at least one selected from the group consisting of a thermoplastic resin and a metal, the layer structure (Y) includes a PO layer (D) or a paper layer, a density difference (X-Y) between the layer structure (X) and the layer structure (Y) is 0.2 g/cm³ or more, an oxygen transmission rate (OTR) of at least one of the layer structure (X) and the layer structure (Y) measured in accordance with JIS K7126-2 (equal pressure method; 2006) at 20° C. and 65% RH is 20 cc/(m²·day·atm) or less, and the water-soluble layer (A) contains a hydroxyl group-containing resin (a1) and an alkali metal ion (a2), and a content of the alkali metal ion (a2) in the water-soluble layer (A) is 10 ppm or more and 2,000 ppm or less. Due to the density difference (X-Y) between the layer structure (X) and the layer structure (Y) being 0.2 g/cm³ or more, i.e., the density of the layer structure (X) being higher than the density of the layer structure (Y) by 0.2 g/cm³ or more, peelability in the separation step tends to be superior. In this regard, as referred to herein, “peelability in the separation step” means peelability in a separation step of dissolving a part or all of the water-soluble layer (A) in the water (W) to separate the layer structure (X) and the layer structure (Y) as described later, and specifically, this peelability can be evaluated by the method described in EXAMPLES. In addition, due to OTR of at least one of the layer structure (X) and the layer structure (Y) being 20 cc/(m²·day·atm) or less, a superior oxygen barrier property is exhibited, whereby in, for example, use of the multilayer structure of the present invention as a food wrapping material, or the like, deterioration of the contents tends to be inhibited. Furthermore, due to the water-soluble layer (A) containing the hydroxyl group-containing resin (a1) and the alkali metal ion (a2), and the content of the alkali metal ion (a2) in the water-soluble layer (A) being 10 ppm or more and 2,000 ppm or less, interlayer adhesiveness under high humidity and peelability in the separation step tend to be both exhibited.

In the multilayer structure of the present invention, the density difference (X-Y) between the layer structure (X) and the layer structure (Y) is 0.2 g/cm³ or more. When the density difference is less than 0.2 g/cm³, peelability in the separation step tends to be insufficient. Although the reason for this event is not certain, it is presumed that the difference between flotation and sedimentation resulting from the density difference between the layer structure (X) and the layer structure (Y) in the separation step, is in concert with adequate solubility of the water-soluble layer (A) described late, thereby leading to an influence on the peelability in the separation step. This finding was first found due to characteristics of the water-soluble layer (A) described later and the density difference (X-Y) falling within an appropriate range. Also, in a case in which an external force is imparted in the separation step by stirring and/or the like, it is presumed that a force in a peeling direction resulting from the density difference between the layer structure (X) and the layer structure (Y) works to influence peelability. The density difference (X-Y) is preferably 0.25 g/cm³ or more, and more preferably 0.3 g/cm³ or more. The density difference (X-Y) may be 2.0 g/cm³ or less, or may be 1.0 g/cm³ or less. Also in light of executing separation by sedimentation of the layer structure (X) and flotation of the layer structure (Y) in the separation step, the density difference (X-Y) falling with in the above range is preferred.

In the multilayer structure of the present invention, the OTR of at least one of the layer structure (X) and the layer structure (Y) at 20° C. and 65% RH is 20 cc/(m²·day·atm) or less. When both the OTRs of the layer structure (X) and the layer structure (Y) are more than the above range, deterioration of quality of contents such as putrefaction and/or transubstantiation of the contents is likely to occur. The OTR of at least one of the layer structure (X) and the layer structure (Y) is more preferably 10 cc/(m²·day·atm) or less, and still more preferably 3 cc/(m²·day·atm) or less. The lower limit of the OTR of at least one of the layer structure (X) and the layer structure (Y) may be 0.01 cc/(m²·day·atm). may be 0.1 cc/(m²·day·atm), or may be 0.5 cc/(m²·day·atm). The OTR is measured in accordance with JIS K7126-2 (equal pressure method; 2006), and specifically, the method described in EXAMPLES is employed.

### Layer Structure (X)

The layer structure (X) includes the substrate layer (B), and has a density being more than that of the layer structure (Y) described later, by 0.2 g/cm³ or more. The density of the layer structure (X) used in the present invention is preferably 1.0 g/cm³ or more. When the density of the layer structure (X) is 1.0 g/cm³ or more, sedimentation of the layer structure (X) is enabled in the case in which the solvent (water (W)) used in the collecting step is water. The density of the layer structure (X) is more preferably 1.05 g/cm³ or more, still more preferably 1.10 g/cm³ or more, and particularly preferably 1.20 g/cm³ or more. The density of the layer structure (X) may be 3.0 g/cm³ or less, may be 2.0 g/cm³ or less, or may be 1.6 g/cm³ or less.

### Substrate layer (B)

The substrate layer (B) contains at least one selected from the group consisting of a thermoplastic resin and a metal. The substrate layer (B) is preferably a layer containing at least one selected from the group consisting of a thermoplastic resin and a metal as a principal component. A content of the at least one selected from the group consisting of a thermoplastic resin and a metal in the substrate layer (B) is preferably 80% by mass or more and 100% by mass or less, more preferably 95% by mass or more and 100% by mass or less, and may be still more preferably 98% by mass or more and 100% by mass or less.

In the case in which the substrate layer (B) contains the thermoplastic resin, examples of the thermoplastic resin include polyolefins (polyethylene, polypropylene, poly 1-butene, poly(4-methyl-1-pentene), an ethylene-propylene copolymer, a copolymer of ethylene with an α-olefin having 4 or more carbon atoms, a copolymer of polyolefin with maleic anhydride, an ethylene-vinyl ester copolymer, an ethylene-vinyl alcohol copolymer, ethylene-acrylic acid ester copolymer, or modified polyolefins obtained from the same by graft modification with an unsaturated carboxylic acid or a derivative thereof, and the like), polyamides (nylon 6, nylon 66, nylon 6/66 copolymer, nylon 11, nylon 12, polymetaxylyleneadipamide, and the like), polyester resins (polyethylene terephthalate, polybutylene terephthalate, polyethylene naphthalate, and the like), polyvinyl chloride, polyvinylidene chloride, polystyrene, polyacrylonitrile, polyurethane, polycarbonate, polyacetal, polyacrylate, and the like. Of these, in light of a balance of heat resistance and mechanical properties being superior, and of being possible to increase the density of the layer structure (X), the substrate layer (B) preferably contains the polyester resin as a principal component, the substrate layer (B) is more preferably the polyester resin, and the substrate layer (B) is still more preferably polyethylene terephthalate. Also, in the case in which the layer structure (Y) incudes the paper layer, the substrate layer (B) preferably includes a polyolefin layer and a barrier layer. As such a polyolefin, a suitable mode described later in connection with the PO layer (D) is preferably used. In addition, as such a barrier layer, a suitable mode described later in connection with the barrier layer (E) is preferably used.

The substrate layer (B) in the case of containing the thermoplastic resin may contain various types of additives, within a range not leading to inhibition of the effects of the present invention. Such an additive is exemplified by a heat stabilizer, an antioxidant, an ultraviolet ray-absorbing agent, a plasticizer, an antistatic agent, a lubricant, a colorant, a filler, a stabilizer, a surfactant, a drying agent, a crosslinking agent, a fiber-reinforcing agent, and the like. A content of these additives in the substrate layer (B) is typically 5% by mass or less, preferably 3% by mass or less, and more preferably 1% by mass or less.

In the case of containing the metal, the substrate layer (B) preferably includes a metal foil, and may be a layer consisting of a metal foil. The metal foil is exemplified by at least one type of metal selected from the group consisting of gold, silver, copper, nickel, stainless, a magnesium alloy, and aluminum, and the like, and in light of economic efficiency and gas barrier properties, an aluminum foil is preferred.

The substrate layer (B) may be configured with a monolayer, or may be configured with a plurality of layers. An average thickness of the substrate layer (B) may be, for example, 10 μm or more and 300 μm or less, may be 25 μm or more and 150 μm or less, or may be 75 μm or more and 150 μm or less. It is to be noted that the average thickness of the substrate layer (B) as referred to herein means an averaged value of thicknesses measured at ten arbitrary sites of the cross section by any of various types of microscopes and the like. The average thickness of the other layer is also an averaged value of thicknesses measured at ten arbitrary sites of the cross section may be measured by any of various types of microscopes and the like.

### Inorganic Vapor Deposition Layer (I)

In light of setting the OTR at 20° C. and 65% RH to be 20 cc/(m²·day·atm) or less, the layer structure (X) may preferably include an inorganic vapor deposition layer (I) on the surface of the substrate layer (B). The inorganic vapor deposition layer (I) is a layer formed by vapor deposition and consists of an inorganic substance such as a metal or an inorganic oxide. The inorganic vapor deposition layer (I) has favorable gas barrier properties against oxygen and/or water vapor. The average thickness of the inorganic vapor deposition layer (I) is typically less than 500 nm. When the average thickness is less than 500 nm, superior stability of viscosity in melt molding of ground matter of the multilayer structure including the inorganic vapor deposition layer (I) is exhibited and generation of gels and/or aggregates can be inhibited, whereby recyclability tends to be superior. An average thickness of the inorganic vapor deposition layer (I) may be 1 nm or more. In light of maintaining superior quality after recycling of the layer structure (X), it may be preferred that the layer structure (X) does not include the inorganic vapor deposition layer (I). On the other hand, due to the layer structure (X) having superior gas barrier properties, the layer structure (Y) becomes more likely to be monomaterialized, whereby recyclability of the layer structure (Y) may be improved. In such an instance, the layer structure (X) preferably includes the inorganic vapor deposition layer (I).

The inorganic vapor deposition layer (I) is preferably any one of a metal vapor deposition layer and an inorganic oxide-vapor deposition layer. In a case in which light shielding properties are to be imparted, the metal vapor deposition layer is preferred; however, the inorganic oxide-vapor deposition layer is preferred in light of visibility of contents and/or oven suitability as a packaging material, as well as capabilities of inhibiting generation of gel and/or aggregates in melt molding of ground matter.

The metal vapor deposition layer may be an aluminum vapor deposition layer. The aluminum vapor deposition layer is a layer containing aluminum as a principal component. The content of aluminum atoms in the metal vapor deposition layer is preferably 50 mol % or more, more preferably 70 mol % or more, still more preferably 90 mol % or more, and particularly preferably 95 mol % or more. The average thickness of the metal vapor deposition layer is preferably 120 nm or less, more preferably 100 nm or less, and still more preferably 90 nm or less. In addition, the average thickness of the metal vapor deposition layer is preferably 25 nm or more, more preferably 35 nm or more, and still more preferably 45 nm or more. In the case in which the substrate layer (B) has the metal vapor deposition layer, a light transmittance at a wavelength of 600 nm may be, for example, 10% or less, whereby superior light shielding properties may be exhibited.

The inorganic oxide-vapor deposition layer is exemplified by vapor deposition films of: inorganic oxides such as, e.g., oxides of silicon, aluminum, magnesium, calcium, potassium, tin, sodium, boron, titanium, lead, zirconium, yttrium, or the like; and preferably alumina (oxide of aluminum) or silica (oxide of silicon). The average thickness of the inorganic oxide-vapor deposition layer is preferably 80 nm or less, more preferably 60 nm or less, and still more preferably 50 nm or less. Also, the average thickness of the inorganic oxide-vapor deposition layer is preferably 10 nm or more, more preferably 15 nm or more, and still more preferably 20 nm or more. In the case in which the substrate layer (B) has the inorganic oxide-vapor deposition layer, the light transmittance at a wavelength of 600 nm can be, for example, 80% or more, whereby superior visibility of contents in cases of use as a packaging material may be exhibited.

Film formation of the inorganic vapor deposition layer (I) is enabled by a well-known physical vapor deposition process or a chemical vapor deposition process. Specifically, a vacuum deposition process, a sputtering process, an ion plating process, an ion beam mixing process, a plasma CVD process, a laser CVD process, an MO-CVD process, a thermal CVD process, and the like are exemplified, the physical vapor deposition process is preferably used, and of these, using the vacuum deposition process is particularly preferred. It is to be noted that, as long as the effects of the invention are not impaired, as needed, a protective layer (top coating layer) may be provided on the inorganic vapor deposition layer (I). The upper limit of a temperature of the surface during film formation of the inorganic vapor deposition layer (I) is preferably 60° C., more preferably 55° C., and still more preferably 50° C. Furthermore, the lower limit of the temperature of the surface during film formation of the inorganic vapor deposition layer (I) is not particularly limited. but is preferably 0° C., more preferably 10° C., and still more preferably 20° C. Prior to performing the film formation, the face to be processed by the film formation may be subjected to a plasma treatment. As the plasma treatment, a well-known method may be used, and an atmospheric-pressure plasma treatment is preferred. In the atmospheric-pressure plasma treatment, nitrogen, helium, neon, argon, krypton, xenon, radon, or the like is used as a discharge gas. Of these, nitrogen, helium, or argon is preferably used, and due to capabilities of cost reduction, nitrogen is particularly preferred.

### Adhesive Layer (C)

The layer structure (X) may include the adhesive layer (C) in order to enhance interlayer adhesiveness. In the case in which the layer structure (X) includes the adhesive layer (C), the adhesive layer (C) being in direct contact with the water-soluble layer (A) (being adjacent) in the multilayer structure of the present invention is preferred in light of further enhancing the interlayer adhesiveness under high humidity between layers. In other words, due to the water-soluble layer (A) being laminated to the substrate layer (B) via the adhesive layer (C), the interlayer adhesiveness is improved, whereby quality as a packaging material or the like is improved, and interlayer adhesiveness under high humidity is also improved. In the multilayer structure of the present invention, it is preferred that the water-soluble layer (A), the adhesive layer (C), and the substrate layer (B) are directly laminated in this order. Alternatively, it is preferred that the water-soluble layer (A), the adhesive layer (C), the inorganic vapor deposition layer (I), and the substrate layer (B) are directly laminated in this order. An average thickness of the adhesive layer (C) is preferably 10 nm or more and 25 μm or less, and more preferably 20 nm or more and 15 μm or less. For example, in a case in which the adhesive layer (C) contains, as a principal component, an adhesive resin described later, the average thickness of the adhesive layer (C) may be, for example, 0.5 μm or more and 25 μm or less, or may be 1 μm or more and 15 μm or less. In a case in which the adhesive layer (C) is formed from an anchor coating agent described later and/or an adhesive other than the adhesive resin, the average thickness of the adhesive layer (C) may be, for example, 10 nm or more and 1 μm or less, or may be 20 nm or more and 200 nm or less.

The adhesive layer (C) preferably contains as a principal component, an adhesive resin such as, for example, a carboxylic acid-modified polyolefin and a carboxylic acid-modified polyester, and more preferably consists of the adhesive resin. The carboxylic acid-modified polyolefin may be exemplified by modified olefin polymers each containing a carboxyl group, which are obtained by chemically bonding an unsaturated carboxylic acid or an anhydride thereof to an olefin polymer by an addition reaction, a graft reaction, and/or the like. Examples of the unsaturated carboxylic acid or the anhydride thereof include maleic acid, maleic anhydride, fumaric acid, acrylic acid, methacrylic acid, crotonic acid, itaconic acid, citraconic acid, hexahydrophthalic anhydride, and the like, and of these, maleic anhydride may be suitably used. Specifically, one type or a mixture of two or more types selected from the group consisting of maleic anhydride-graft modified polyethylene, maleic anhydride-graft modified polypropylene, maleic anhydride-graft modified ethylene-propylene copolymers, maleic anhydride-graft modified ethylene-ethyl acrylate copolymers, maleic anhydride-graft modified ethylene-vinyl acetate copolymers, and the like may be given as suitable candidates. An amount of an ethylenic unsaturated carboxylic acid or an anhydride thereof added to the olefin-derived polymer, or an amount of grafting (degree of modification) is, with respect to the olefin-derived polymer, 0.01 to 15% by mass, and preferably 0.02 to 10% by mass. When a rubber-elastomer component such as polyisobutylene or ethylene-propylene rubber, and/or a polyolefin resin that differs from the polyolefin resin being a matrix of the original adhesive resin is/are mixed with the adhesive resin, the adhesiveness may be improved.

The adhesive layer (C) can be formed also by performing a treatment with a well-known anchor coating agent, or coating with a well-known adhesive. The anchor coating agent and/or the adhesive is/are preferably a two-reactive component polyurethane-based adhesive which is used by mixing a polyisocyanate component and a polyol component to allow for a reaction. Also, further enhancing the adhesiveness may be possible by adding a small amount of an additive such as a well-known silane coupling agent to the anchor coating agent and/or the adhesive. Examples of the silane coupling agent include silane coupling agents each having a reactive group such as an isocyanate group, an epoxy group, an amino group, a ureide group, or a mercapto group, but the silane coupling agent is not particularly limited thereto.

### Layer Configuration of Layer Structure (X)

The layer structure (X) may be configured with only the substrate layer (B), may be configured with only the substrate layer (B) and the inorganic vapor deposition layer (I), may be configured with only the substrate layer (B) and the adhesive layer (C), or may be configured with only the substrate layer (B), the inorganic vapor deposition layer (I), and the adhesive layer (C). The layer structure (X) may have other layer(s) aside from the substrate layer (B), the inorganic vapor deposition layer (I), and the adhesive layer (C). It is preferred that the layer structure (X) includes the substrate layer (B) as an outermost layer of at least one side, in light of capabilities of imparting various functions needed, such as heat resistance, mechanical properties, and gas barrier properties, depending on the type of the substrate layer (B). From a similar point of view, the multilayer structure of the present invention preferably includes the substrate layer (B) as an outermost layer of one side.

The layer structure (X) may be configured with a monolayer, or may be configured with a plurality of layers. In the case in which the layer structure (X) is a multilayer structure, the number of its layers is preferably two or more and six or less, in light of functions such as gas barrier properties and adhesiveness to be economically imparted. Furthermore, the average thickness of the layer structure (X) is, in light of handleability as a packaging material and resource saving, preferably 10 μm or more and 300 μm or less, more preferably 25 μm or more and 150 μm or less, and may be 75 μm or more and 150 μm or less. A suitable mode of a layer configuration of the layer structure (X), may be exemplified by: a polyethylene terephthalate layer (hereinafter, may be abbreviated to “PET layer”); the PET layer/the inorganic vapor deposition layer (I); the PET layer/the adhesive layer (C); the PET layer/the inorganic vapor deposition layer (I)/the adhesive layer (C); the PET layer/the adhesive layer (C)/the aluminum foil layer; the PET layer/the adhesive layer (C)/the aluminum foil layer/the adhesive layer (C); the aluminum foil layer; the aluminum foil layer/the adhesive layer (C), and the like. It is to be noted that in the case in which the layer structure (Y) includes the paper layer, a suitable mode of the layer configuration of the layer structure (X) may be exemplified by: a polyolefin layer (hereinafter, may be abbreviated to “PO layer”); the PO layer/the adhesive layer (C); the PO layer/the adhesive layer (C)/the barrier layer; the PO layer/the adhesive layer (C)/the barrier layer/the adhesive layer (C); the PO layer/the adhesive layer (C)/the barrier layer/the adhesive layer (C)/the PO layer; the PO layer/the adhesive layer (C)/the barrier layer/the adhesive layer (C)/the PO layer/the adhesive layer (C); and the like. It is to be noted that in the layer configuration of the layer structure (X) exemplified, the “PET layer”, the “aluminum foil layer”, the “PO layer”, and the “barrier layer” fall under the category of the substrate layer (B).

### Layer Structure (Y)

The layer structure (Y) includes the PO layer (D) or the paper layer, and has a density being less than that of the layer structure (X) by 0.2 g/cm³ or more. The layer structure (Y) preferably includes the PO layer (D). The density of the layer structure (Y) is preferably 1.0 g/cm³ or less. When the density of the layer structure (Y) is 1.0 g/cm³ or less, flotation of the layer structure (Y) is enabled in the case in which the solvent (water (W)) used in the collecting step is water. The density of the layer structure (Y) is more preferably 0.98 g/cm³ or less, and still more preferably 0.95 g/cm³ or less. The density of the layer structure (Y) may be 0.8 g/cm³ or more, may be 0.85 g/cm³ or more, or may be 0.90 g/cm³ or more.

### PO layer (D)

The PO layer (D) is a layer typically containing a polyolefin as a principal component. Since the polyolefin is a resin which is superior in recyclability, when the layer structure (Y) includes the PO layer (D), favorable recyclability after the separation step may be exhibited. The polyolefin constituting the PO layer (D) is not particularly limited, and is exemplified by a homopolymer of an olefin or a copolymer thereof, and the like, such as a linear low-density polyethylene, a low-density polyethylene, a medium-density polyethylene, a high-density polyethylene, a vinyl ester resin, an ethylene-propylene copolymer, an ethylene-α-olefin copolymer (α-olefin having 4 to 20 carbon atoms), polypropylene, a propylene-α-olefin copolymer (α-olefin having 4 to 20 carbon atoms), polybutene, and polypentene. Of these, in light of melt formability, separability, and economic efficiency, at least one selected from the group consisting of the linear low-density polyethylene, the low-density polyethylene, and polypropylene is preferred.

The PO layer (D) may contain additive(s). The additive may be exemplified by a heat stabilizer, an antioxidant, an ultraviolet ray-absorbing agent, a plasticizer, an antistatic agent, a lubricant, a colorant, a filler, a stabilizer, a surfactant, a crosslinking agent, a fiber-reinforcing agent, and the like. Of these, containing at least one selected from the group consisting of the antioxidant, the ultraviolet ray-absorbing agent, and the colorant may be preferred. The PO layer (D) is preferably a layer in which the resin constituting the PO layer (D) is constituted from only a polyolefin. A proportion of the PO layer (D) accounted for by the polyolefin may be 80% by mass or more, may be 90% by mass or more, may be 95% by mass or more, or may be 99% by mass or more.

The layer structure (Y) preferably includes the PO layer (D) as an outermost layer, in light of capabilities of imparting heat sealing properties to the multilayer structure to be obtained. Similarly, the multilayer structure of the present invention preferably includes the PO layer (D) as an outermost layer of one side.

An average thickness of one layer of the PO layer (D) is preferably 1 μm or more and 100 μm or less, and more preferably 5 μm or more and 50 μm or less.

### Paper Layer

When the layer structure (Y) includes the paper layer, a decrease in the transport cost of packaging materials is enabled by reduction in weight of the multilayer structure. The paper layer is not particularly limited, and for example, a paper such as a natural paper, a synthetic paper, a kraft paper, a pure paper, a simili paper, a glassine paper, a parchment paper, a synthetic paper, a white board, a manila board, a milk-carton board, a cupboard, an ivory paper, or a platinum paper may be used.

### Barrier Layer (E)

The layer structure (Y) may preferably include the barrier layer (E) containing at least one selected from the group consisting of the PA and the EVOH as a principal component, in light of the OTR at 20° C. and 65% RH to be 20 cc/(m²·day·atm) or less. When the barrier layer (E) containing the polyamide or the EVOH as a principal component is included, the oxygen barrier property of the multilayer structure is improved. Moreover, in light of recyclability after the separation step, the principal component constituting the barrier layer (E) is more preferably the EVOH.

Examples of the PA include polycaproamide (nylon 6), poly-ω-aminoheptanoic acid (nylon 7), poly-ω-aminononanoic acid (nylon 9), polyundecanamide (nylon 11), polylauryllactam (nylon 12), polyethylenediamine adipamide (nylon 26), polytetramethylene adipamide (nylon 46), polyhexamethylene adipamide (nylon 66), polyhexamethylene sebacamide (nylon 610), polyhexamethylene dodecamide (nylon 612), polyoctamethylene adipamide (nylon 86), polydecamethylene adipamide (nylon 106), caprolactam/lauryllactam copolymers (nylon 6/12), caprolactam/ω-aminononanoic acid copolymers (nylon 6/9), caprolactam/hexamethylenediammonium adipate copolymers (nylon 6/66), lauryllactam/hexamethylenediammonium adipate copolymers (nylon 12/66), ethylene diammonium adipate/hexamethylenediammonium adipate copolymers (nylon 26/66), caprolactam/hexamethylenediammonium adipate/hex amethylenediammonium sebacate copolymers (nylon 6/66/610), ethylenediammonium adipate/hexamethylenediammonium adipate/hexamethylenediammonium sebacate copolymers (nylon 26/66/610), polyhexamethylene isophthalamide (nylon 6I), polyhexamethylene terephthalamide (nylon 6T), hexamethylene isophthalamide/hexamethylene terephthalamide copolymers (nylon 6I/6T), 11-aminoundecaneamide/hexamethylene terephthalamide copolymers, metaxylenediamine/adipic acid copolymers (nylon MXD6), polynonamethylene terephthalamide (nylon 9T), polydecamethylene terephthalamide (nylon 10T), polyhexamethylene cyclohexylamide, and polynonamethylene cyclohexylamide, as well as these polyamides modified with an aromatic amine such as methylenebenzylamine or metaxylenediamine. In addition, one modified with metaxylylenediammonium adipate and the like may be also exemplified. Of these, in light of economic efficiency, melt formability, and mechanical properties each being superior, the PA is preferably nylon 6/66 or nylon 6. Moreover, in light of the gas barrier properties, an aromatic polyamide (a polyamide including a monomer unit having an aromatic ring, or a polyamide modified with a modifying agent having an aromatic ring) is preferred, and nylon MXD6 is more preferred.

In the case in which the barrier layer (E) contains the PA, the barrier layer (E) may also contain other additive(s) aside from the PA, within a range not leading to inhibition of the effects of the present invention. Such an other additive is exemplified by a resin other than the PA, a heat stabilizer, an antioxidant, an ultraviolet ray-absorbing agent, a plasticizer, an antistatic agent, a lubricant, a colorant, a filler, a stabilizer, a surfactant, a drying agent, a crosslinking agent, a fiber-reinforcing agent, and the like. A content of the other additive in the barrier layer (E) is typically 5% by mass or less, preferably 3% by mass or less, and more preferably 1% by mass or less.

An ethylene content of the EVOH is 20 mol % or more, and preferably 25 mol % or more. When the ethylene content of the EVOH is 20 mol % or more, flexibility and thermoformability of the resin composition of the layer structure (Y) may be improved, whereby thermoformability of the multilayer structure to be obtained may be improved. In addition, the ethylene content is preferably 55 mol % or less, and more preferably 50) mol % or less. When the ethylene content of the EVOH is 55 mol % or less, the gas barrier properties may be improved.

The degree of saponification of the EVOH is, in light of gas barrier properties and thermal stability, preferably 95 mol % or more, more preferably 98 mol % or more, and still more preferably 99 mol % or more. The degree of saponification of the EVOH may be 100 mol % or less.

A melt flow rate (MFR) of the EVOH at 210° C. under a load of 2,160 g is, in light of melt formability and extrusion moldability, preferably 0.1 g/10 min or more and 50 g/10 min or less. The MFR is more preferably 0.5 g/10 min or more, and still more preferably 1 g/10 min or more. Also, the MFR is more preferably 20 g/10 min or less, and still more preferably 10 g/10 min or less.

The EVOH may have, within a range not leading to inhibition of the objects of the present invention, a unit derived from an other monomer aside from ethylene, a vinyl ester, and a saponification product thereof. In the case in which the EVOH has the other monomer unit, a content of each of the other monomer unit with respect to total monomer units of each of the EVOH is preferably 30 mol % or less, more preferably 20 mol % or less, still more preferably 10 mol % or less, and particularly preferably 5 mol % or less. Furthermore, in the case in which the EVOH has a unit derived from the other monomer, the lower limit value may be 0.05 mol %, or may be 0.10 mol %. Examples of the other monomer include: alkenes such as propylene, butylene, pentene, and hexene; alkenes having an ester group such as 3-acyloxy-1-propene, 3-acyloxy-1-butene, 4-acyloxy-1-butene, 3,4-diacyloxy-1-butene, 3-acyloxy-4-methyl-1-butene, 4-acyloxy-2-methyl-1-butene, 4-acyloxy-3-methyl-1-butene, 3,4-diacyloxy-2-methyl-1-butene, 4-acyloxy-1-pentene, 5-acyloxy-1-pentene, 4,5-diacyloxy-1-pentene, 4-acyloxy-1-hexene, 5-acyloxy-1-hexene, 6-acyloxy-1-hexene, 5,6-diacyloxy-1-hexene, and 1,3-diacetoxy-2-methylenepropane, and saponification products thereof; unsaturated acids such as acrylic acid, methacrylic acid, crotonic acid, and itaconic acid, and anhydrides, salts, and mono- or dialkyl esters thereof; nitriles such as acrylonitrile and methacrylonitrile; amides such as acrylamide and methacrylamide; olefin sulfonic acids such as vinylsulfonic acid, acrylsulfonic acid, and methacrylsulfonic acid, and salts thereof; vinylsilane compounds such as vinyltrimethoxysilane, vinyltriethoxysilane, vinyltri(β-methoxy-ethoxy)silane, and γ-methacryloxypropylmethoxysilane; alkyl vinyl ethers; vinyl ketone; N-vinylpyrrolidone; vinyl chloride; vinylidene chloride; and the like.

The EVOH may be subjected to post-modification with a process such as urethanization, acetalization, cyanoethylation, oxyalkylenation, or the like.

The EVOH may be used alone of one type, or two or more types thereof may be used in combination.

In the case in which the barrier layer (E) contains the EVOH, the barrier layer (E) may contain, within a range not leading to inhibition of the effects of the present invention, other additive(s) aside from the EVOH. The other additive is exemplified by an antiblocking agent, a processing aid, a resin other than the EVOH, a carboxylic acid compound, a phosphorus compound, a boron compound, a metal salt, a stabilizer, an antioxidant, an ultraviolet ray-absorbing agent, a plasticizer, an antistatic agent, a lubricant, a colorant, a filler, a surfactant, a drying agent, a crosslinking agent, a reinforcing agent such as various types of fibers, and the like.

The resin other than the PA or the EVOH, which may be used as the other additive(s) is not particularly limited, and is exemplified by thermoplastic resins such as: a polyolefin; a polyester; a polystyrene; a polyvinyl chloride; an acrylic resin; a polyurethane; a polycarbonate; and a polyvinyl acetate.

In the case in which the barrier layer (E) contains the PA and the EVOH, a proportion of the resin constituting the barrier layer (E) accounted for by the PA and the EVOH is preferably 80% by mass or more, more preferably 90% by mass or more, still more preferably 95% by mass or more, and particularly preferably 99% by mass or more. In the case in which the barrier layer (E) contains the PA and the EVOH, a proportion of the barrier layer (E) accounted for by the PA and the EVOH is preferably 80% by mass or more, more preferably 90% by mass or more, still more preferably 95% by mass or more, and particularly preferably 99% by mass or more. Furthermore, in the case in which the barrier layer (E) contains the PA, a proportion of the resin constituting the barrier layer (E) accounted for by the PA is preferably 80% by mass or more, more preferably 90% by mass or more, still more preferably 95% by mass or more, and particularly preferably 99% by mass or more. In the case in which the barrier layer (E) contains the PA, a proportion of the barrier layer (E) accounted for by the PA is preferably 80% by mass or more, more preferably 90% by mass or more, still more preferably 95% by mass or more, and particularly preferably 99% by mass or more. Moreover, in the case in which the barrier layer (E) contains the EVOH, a proportion of the resin constituting the barrier layer (E) accounted for by the EVOH is preferably 80% by mass or more, more preferably 90% by mass or more, still more preferably 95% by mass or more, and particularly preferably 99% by mass or more, In the case in which the barrier layer (E) contains the EVOH, a proportion of the barrier layer (E) accounted for by the EVOH is preferably 80% by mass or more, more preferably 90% by mass or more, still more preferably 95% by mass or more, and particularly preferably 99% by mass or more.

An average thickness of one layer of the barrier layer (E) is preferably 0.5 μm or more and 10 μm or less, and more preferably I um or more and 5 μm or less.

### Other Layer(s)

The layer structure (Y) may include the adhesive layer (C) described above. In the case in which the layer structure (Y) includes the adhesive layer (C), the adhesive layer (C) may be laminated between the PO layer (D) or the paper layer and the barrier layer (E), may be laminated between the other layer described later and the PO layer (D), the paper layer, or the barrier layer (E), or may be in contact with the water-soluble layer (A). A configuration in which the layer structure (Y) includes the adhesive layer (C), and the PO layer (D) or the paper layer is laminated with the another layer (the water-soluble layer (A), the barrier layer (E), or the other layer) via the adhesive layer (C); a configuration in which the layer structure (Y) includes the adhesive layer (C), and the PO layer (D) or a layer other than the paper layer is laminated with the water-soluble layer (A) via the adhesive layer (C); and the like are involved in a suitable mode. When the layer structure (Y) includes the adhesive layer (C), interlayer adhesiveness under high humidity may be further enhanced.

The layer structure (Y) may include other layer(s) aside from the adhesive layer (C), the PO layer (D), the paper layer, and the barrier layer (E). When the layer structure (Y) includes the other layer(s) described above, desired performance can be imparted. On the other hand, in light of recyclability, there is a case in which the layer structure (Y) not including the other layer is preferred. Example of the other layer include: the inorganic vapor deposition layer (I); metal foils of gold, silver, copper, nickel, stainless, magnesium alloy, aluminum, or the like; layers of polyester resins such as polyethylene terephthalate, polybutylene terephthalate, and polyethylene naphthalate; layers of polyvinyl chloride, polyvinylidene chloride, polystyrene, polyacrylonitrile, polyurethane, polycarbonate, polyacetal, polyacrylate, or the like.

Layer configuration of layer structure (Y), etc.

A ratio (D/Y) of the mass of PO layer (D) to a total mass of the layer structure (Y) is preferably 0.90 or more. When the ratio of the mass falls within the above range, the recyclability of the layer structure (Y) after separating the multilayer structure of the present invention into the layer structure (X) and the layer structure (Y) by a separation step described later is improved. The ratio (D/Y) of the mass may be no greater than 1.00, or may be no greater than 0.99.

The layer structure (Y) may be configured with a monolayer, or may be configured with a plurality of layers. In the case in which the layer structure (Y) is a multilayer structure, the number of its layers is preferably two or more and seven or less, in light of functions such as gas barrier properties, adhesiveness, and heat sealing properties to be economically imparted. Furthermore, the average thickness of the layer structure (Y) is, in light of handleability as a packaging material and resource saving, preferably 10 μm or more and 500 μm or less.

The layer configuration of the layer structure (Y) may be exemplified by: the PO layer (D); the adhesive layer (C)/the PO layer (D); the barrier layer (E)/the adhesive layer (C)/the PO layer (D); the adhesive layer (C)/the barrier layer (E)/the adhesive layer (C)/the PO layer (D); the PO layer (D)/the adhesive layer (C)/the barrier layer (E)/the adhesive layer (C)/the PO layer (D); the adhesive layer (C)/the PO layer (D)/the adhesive layer (C)/the barrier layer (E)/the adhesive layer (C)/the PO layer (D); the paper layer; the adhesive layer (C)/the paper layer; and the like.

### Water-Soluble Layer (A)

The water-soluble layer (A) contains the hydroxyl group-containing resin (a1) and the alkali metal ion (a2), and a content of the alkali metal ion (a2) in the water-soluble layer (A) is 10 ppm or more and 2,000 ppm or less. When the water-soluble layer (A) has the above-described constitution, favorable peelability can be achieved even in the separation step, while interlayer adhesiveness under high humidity is exhibited. Although the reason for this event is not certain, it is presumed to result from high solubility in water, as water can be efficiently incorporated via the alkali metal ion (a2). It is speculated that due to the water-soluble layer (A) having such a property, achieving such an unexpectable advantageous effect on the peelability becoming favorable is enabled when the density difference (X-Y) is 0.2 g/cm³ or more. The water-soluble layer (A) is typically a layer in which a part or all of the principal component constituting the same is dissolved in the water (W), and may be a layer in which a part or all of the principal component constituting the same is dissolved by bringing into contact with the water (W) having a temperature of 20° C. to 95° C.

### Hydroxyl Group-Containing Resin (a1)

The water-soluble layer (A) contains the hydroxyl group-containing resin (a1). The water-soluble layer (A) preferably contains the hydroxyl group-containing resin (a1) as a principal component. The hydroxyl group-containing resin (a1) as referred to herein means a resin containing a hydroxyl group. In light of increasing the solubility in the water (W) described later, a proportion of the monomer unit having a hydroxyl group in total monomer units of the hydroxyl group-containing resin (a1) is preferably 80 mol % or more, more preferably 85 mol % or more, and may be 90 mol % or more or 95 mol % or more. On the other hand, the proportion of the monomer unit having a hydroxyl group in total monomer units of the hydroxyl group-containing resin (a1) may be 100 mol % or less, or may be 99 mol % or less.

Examples of the hydroxyl group-containing resin (a1) include: starch components such as corn starch and polymer components thereof; cellulose polymers such as carboxymethylcellulose and carboxyethylcellulose; acrylic acid polymers such as sodium polyacrylate; PVA; and the like. Of these, in light of melt formability and/or adhesiveness to the barrier layer (E), the PVA is preferred. When the PVA is contained as a principal component, gas barrier properties under high humidity of the multilayer structure and peelability in the separation step may be improved. It is to be noted that the EVOH as referred to herein means one having an ethylene unit content of 20 mol % or more, and the PVA as referred to herein means one having a vinyl alcohol unit and having an ethylene unit content of less than 20 mol %.

The viscosity-average degree of polymerization of the PVA is preferably 400 or more and 2,000 or less. The lower limit of the viscosity degree of polymerization is more preferably 500, and still more preferably 700. When the viscosity-average degree of polymerization is 400 or more, adhesiveness and/or thermal stability of the PVA may be improved. The upper limit of the viscosity-average degree of polymerization is more preferably 1,500, and still more preferably 1,000. When the viscosity-average degree of polymerization is 2,000 or less, melt formability of the PVA may be improved.

The viscosity-average degree of polymerization of the PVA is determined in accordance with JIS K 6726 (1994). Specifically, a limiting viscosity [η] (liter/g) of the PVA is measured in water at 30° C., and a viscosity-average degree of polymerization P is calculated using the value of the limiting viscosity [η], according to the following equality. It is to be noted that in cases in which the degree of saponification of the PVA is less than 99.5 mol %, the limiting viscosity [η] is measured after saponification until the degree of saponification becomes 99.5 mol % or more.

P=([η]×10⁴/8.29)^{(1/0.62})

The degree of saponification of the PVA is preferably 70 mol % or more, more preferably 75 mol %, and still more preferably 85 mol % or more. When the degree of saponification is 70 mol % or more, the water solubility of the PVA may be superior, and thus the peelability of the multilayer structure in the separation step may be improved. The degree of saponification of the PVA is preferably 95 mol % or less, more preferably 93 mol % or less, and still more preferably 90 mol % or less. When the degree of saponification is 95 mol % or less, melt formability of the PVA may be superior. The degree of saponification of the PVA is determined in accordance with JIS K6726 (1994).

A total of contents of a vinyl alcohol unit and a vinyl ester unit in total monomer units constituting the PVA is preferably 95 mol % or more. When the total of the contents is 95 mol % or more, solubility of the PVA in water further improves, and as a result, separability of the multilayer structure may be further improved. The total of the contents of the vinyl alcohol unit and the vinyl ester unit is more preferably 97 mol % or more, still more preferably 98 mol % or more, and particularly preferably 99 mol % or more.

The PVA may contain monomer unit(s), other than the vinyl alcohol unit and the vinyl ester unit, within a range not leading to impairment of the effects of the present invention. Examples of such a monomer include: α-olefins such as an ethylene unit, propylene, n-butene, and isobutylene; acrylic acid and salts thereof; acrylic acid esters; methacrylic acid and salts thereof; methacrylic acid esters; acrylamide; acrylamide derivatives such as N-methylacrylamide, N-ethylacrylamide, N,N-dimethylacrylamide, diacetoneacrylamide, and acrylamidepropanesulfonic acid, and salts thereof, acrylamidepropyldimethylamine and salts thereof or quaternary salts thereof, and N-methylolacrylamide and derivatives thereof; methacrylamide; methacrylamide derivatives such as N-methylmethacrylamide, N-ethylmethacrylamide, methacrylamidepropanesulfonic acid and salts thereof, methacrylamidepropyldimethylamine and salts thereof or quaternary salts thereof, and N-methylolmethacrylamide and derivatives thereof; vinyl ethers such as methyl vinyl ether, ethyl vinyl ether, n-propyl vinyl ether, i-propyl vinyl ether, n-butyl vinyl ether, i-butyl vinyl ether, t-butyl vinyl ether, dodecyl vinyl ether, and stearyl vinyl ether; nitriles such as acrylonitrile and methacrylonitrile; vinyl halides such as vinyl chloride and vinyl fluoride; vinylidene halides such as vinylidene chloride and vinylidene fluoride; allyl compounds such as allyl acetate and allyl chloride; unsaturated dicarboxylic acids such as maleic acid, itaconic acid, and fumaric acid, and salts thereof or esters thereof; vinylsilyl compounds such as vinyltrimethoxysilane; isopropenyl acetate; and the like. A percentage content of these monomers may vary depending on intended usage, purposes in use, and/or the like, and is preferably 10 mol % or less, more preferably less than 5 mol %, still more preferably less than 1 mol %, and particularly preferably less than 0.5 mol %, and may be ( ) mol %. One type of the PVA may be used alone, or two or more types thereof may be used.

### Alkali Metal Ion (a2)

The water-soluble layer (A) contains the alkali metal ion (a2) at a content of 10) ppm or more and 2,000 ppm or less. When the content of the alkali metal ion (a2) falls within the above range, superior adhesiveness under high humidity, and superior peelability in the separation step are exhibited. When the content of the alkali metal ion (a2) is less than 10 ppm, entry of water into the water-soluble layer (A) may not sufficiently proceed in the separation step, whereby water solubility of the water-soluble layer (A) may be insufficient, and as a result, peelability in the separation step may be inferior. The content of the alkali metal ion (a2) is more preferably 100 ppm or more, still more preferably 200 ppm or more, and particularly preferably 500 ppm or more. On the other hand, when the content of the alkali metal ion (a2) is more than 2,000 ppm, entry of water into the water-soluble layer (A) under high humidity condition may be intense, whereby adhesiveness under high humidity may be inferior. The content of the alkali metal ion (a2) is more preferably 1,500 ppm or less, still more preferably 1,200 ppm or less, and particularly preferably 1,000 ppm or less.

Examples of the alkali metal ion (a2) contained in the water-soluble layer (A) include alithium ion, a sodium ion, and a potassium ion. In light of hue and viscosity stability of the resin composition, a sodium ion is preferred.

The alkali metal ion (a2) contained in the water-soluble layer (A) of the present invention may be present in a state given by dissociating from an anion constituting an alkali metal salt, or may be present in a state of a salt bonding the anion. Alternatively, the alkali metal ion (a2) may be present in a state of being coordinated to a group, etc. (for example, a carboxy group, a hydroxyl group, or the like) included in the hydroxyl group-containing resin (a1) such as the PVA, and/or other optional component(s).

The alkali metal ion (a2) is typically derived from a salt, and a component constituting the alkali metal ion (a2) is not particularly limited and the component which may be used is a fatty acid metal salt, a metal salt (a nitric acid salt, a sulfuric acid salt, or the like) other than the fatty acid metal salt, or the like may be used.

The fatty acid metal salt may be either a higher aliphatic acid metal salt having 12 or more carbon atoms, or a fatty acid metal salt having 11 or fewer carbon atoms, and in light of the solubility of the water-soluble layer (A) in the water (W), an aliphatic metal salt having 11 or fewer carbon atoms is preferred. Examples of the higher aliphatic acid metal salt having 12 or more carbon atoms include metal salts of fatty acids such as lauryl acid, lauric acid, tridecyl acid, myristic acid, pentadecyl acid, palmitic acid, heptadecyl acid, stearic acid, basic stearic acid, hydroxystearic acid, basic hydroxystearic acid, nonadecane acid, oleic acid, behenic acid, montanic acid, linoleic acid, and the like. Examples of the fatty acid metal salt having 11 or fewer carbon atoms include an acetic acid salt, a propionic acid salt, and the like, In light of dispersibility in the PVA, and the like, one type or two or more types of these may be used ad libitum.

It is preferred that the water-soluble layer (A) further contains a plasticizer (a3). When the plasticizer (a3) is contained, melt formability with the hydroxyl group-containing resin (a1) such as the PVA, and solubility in the water (W) may be improved. A molecular weight of the plasticizer (a3) is not particularly limited, and is, in light of the peelability, preferably 10,000 or less, more preferably 2,000 or less, still more preferably 200 or less, and particularly preferably 100 or less. A content of the plasticizer (a3) is preferably 3% by mass or more, more preferably 5% by mass or more, and still more preferably 8% by mass or more. The content of the plasticizer (a3) is preferably 45% by mass or less, more preferably 30% by mass or less, and still more preferably 20% by mass or less. The component constituting the plasticizer (a3) is preferably at least one selected from the group consisting of glycerin, polyethylene glycol, polypropylene glycol, polyglycerin, mannitol, sorbitol, and pentaerythritol; more preferably at least one selected from the group consisting of glycerin, polyethylene glycol, mannitol, and sorbitol; and particularly preferably at least one selected from the group consisting of glycerin, mannitol, and sorbitol.

The water-soluble layer (A) may contain other component(s) aside from the hydroxyl group-containing resin (a1), the alkali metal ion (a2), and the plasticizer (a3), within a range not leading to inhibition of the effects of the present invention. Examples of the other component(s) include multivalent metal ions, carboxylic acids, phosphoric acid compounds, oxidization accelerators, antioxidants, heat stabilizers (melt stabilizers), photoinitiators, deodorizers, ultraviolet ray-absorbing agents, antistatic agents, lubricants, colorants, fillers, drying agents, bulking agents, pigments, dyes, processing aids, fire retardants, anti-fogging agents, and the like. A content of the other component in the water-soluble layer (A) is typically 5% by mass or less, preferably 3% by mass or less, and more preferably 1% by mass or less.

A proportion of the water-soluble layer (A) accounted for by the hydroxyl group-containing resin (a1) is preferably 60% by mass or more, more preferably 70% by mass or more, still more preferably 80% by mass or more, and particularly preferably 90% by mass or more, or may be 95% by mass or more, 97% by mass or more, 98% by mass or more, or 99% by mass or more. Furthermore, a proportion of the total resin constituting the water-soluble layer (A) accounted for by the hydroxyl group-containing resin (a1) is preferably 70% by mass or more, more preferably 90% by mass or more, still more preferably 95% by mass or more, and particularly preferably 99% by mass or more, whereas the total resin constituting the water-soluble layer (A) may be substantially constituted from only the hydroxyl group-containing resin (a1). The proportion of the water-soluble layer (A) accounted for by the hydroxyl group-containing resin (a1) and the alkali metal ion (a2) is preferably 70% by mass or more, more preferably 90% by mass or more, still more preferably 95% by mass or more, and particularly preferably 99% by mass or more, whereas the water-soluble layer (A) may be substantially constituted from only the hydroxyl group-containing resin (a1) and alkali metal ion (a2). The proportion of the water-soluble layer (A) accounted for by the hydroxyl group-containing resin (a1) and the alkali metal ion (a2) may be 100% by mass or less, or may be 99% by mass or less. In the case in which the water-soluble layer (A) contains the plasticizer (a3), a proportion of the water-soluble layer (A) accounted for by the hydroxyl group-containing resin (a1), the alkali metal ion (a2), and the plasticizer (a3) is preferably 70% by mass or more, more preferably 90% by mass or more, still more preferably 95% by mass or more, and particularly preferably 99% by mass or more, whereas the water-soluble layer (A) may be substantially constituted from only the hydroxyl group-containing resin (a1), alkali metal ion (a2), and plasticizer (a3). The proportion of the water-soluble layer (A) accounted for by the hydroxyl group-containing resin (a1), the alkali metal ion (a2), and the plasticizer (a3) may be 100% by mass or less.

An average thickness of one layer of the water-soluble layer (A) is preferably 1 μm or more and 20 μm or less, more preferably 2 μm or more and 10 μm or less, and may be still more preferably 3 μm or more and 8 μm or less.

A procedure for preparing the resin composition constituting the water-soluble layer (A) is not particularly limited, and the preparation may be carried out by any procedure as long as homogenously mixing the hydroxyl group-containing resin (a1) and the alkali metal ion (a2), as well as the plasticizer (a3) and/or the other component(s) as needed, is enabled. The vinyl alcohol polymer composition can be prepared by, for example: a procedure of blending the hydroxyl group-containing resin (a1) and the alkali metal ion (a2), as well as the plasticizer (a3) and/or the other component(s) as needed, followed by melt kneading the mixture and pelletization; a procedure of kneading and pelletization in a melt kneading machine, while the hydroxyl group-containing resin (a1) and the alkali metal ion (a2), as well as the plasticizer (a3) and/or the other component(s) as needed are separately charged in a certain ratio; a procedure of introducing the hydroxyl group-containing resin (a1) and the alkali metal ion (a2) beforehand, followed by as needed, blending the plasticizer (a3) and/or the other component(s) therewith, and then melt kneading and pelletization; a procedure of introducing the alkali metal ion (a2) in the hydroxyl group-containing resin (a1) beforehand, followed by kneading and pelletization in a melt kneading machine, while the plasticizer (a3) and/or the other component(s) is/are separately charged in a certain ratio; or the like.

### Multilayer Structure

In the multilayer structure of the present invention, at least one of the layers may be subjected to printing. The printing may be performed on any of the layer configuring the layer structure (X), the layer configuring the layer structure (Y), and the water-soluble layer (A). Two or more layers may be subjected to the printing. Having been subjected to printing may lead to a case in which transparency of the molded product obtained by recycling of the multilayer structure of the present invention deteriorates; therefore, if transparency of the molded product obtained by recycling is required, it is preferred that subjecting to printing is not performed. In other words, in a case in which the molded product obtained by recycling of the layer structure (X) is required to have high transparency, and the molded product obtained by recycling layer structure (Y) is not required to have high transparency, the printing is preferably performed on the water-soluble layer (A) or the layer configuring the layer structure (Y). In other words, in light of recyclability of the layer structure (X), the printing is preferably subjected to the water-soluble layer (A) or the layer configuring the layer structure (Y). Also, in light of recyclability of both the layer structure (X) and the layer structure (Y), the printing is preferably performed on the water-soluble layer (A). The printing is formed by directly printing a well-known ink with a well-known printing method on the layer configuring the layer structure (X), on the layer configuring the layer structure (Y), or on the water-soluble layer (A).

In the multilayer structure of the present invention, the layer structure (X) and the layer structure (Y) are laminated via the water-soluble layer (A). In this case, the layer structure (X) and the layer structure (Y) each may be a monolayer, or may be a multilayer structure constituted from a plurality of layers. The multilayer structure may be a structure in which the water-soluble layer (A) is directly laminated to the substrate layer (B), or may be a structure in which the water-soluble layer (A) is laminated to the substrate layer (B) via the adhesive layer (C). The water-soluble layer (A), the adhesive layer (C), and the substrate layer (B) may be each produced by separate steps, and then may be laminated in a post step by a dry lamination process or the like, or may be sequentially laminated by a solution coating process or the like, or a part or all of these may be simultaneously produced by a coextrusion molding process or the like. A molding temperature during melt molding in the coextrusion molding process or the like is typically selected from the range of 150 to 300° C.

A lamination procedure of the multilayer structure of the present invention may be exemplified by a procedure of: laminating the water-soluble layer (A) beforehand by a solution coating process on the substrate layer (B); and dry laminating thereto, with a well-known adhesive (an adhesive exemplified for the adhesive layer (C), etc.), a layer structure (Y) [the PO layer (D)/an adhesive resin layer (the adhesive layer (C))/the barrier layer (E)/the adhesive resin layer (the adhesive layer (C))/the PO layer (D) or the like] produced separately by coextrusion. It is to be noted that the layer structure (Y) means the layer structure (Y) before providing the adhesive layer (C) for dry lamination. More specifically, in the multilayer structure obtained according to above-described example, the layer structure (X) is constituted from the substrate layer (B), and the layer structure (Y) is constituted with a layer configuration of the adhesive layer (C)/the PO layer (D)/the adhesive layer (C)/the barrier layer (E)/the adhesive layer (C)/the PO layer (D).

The number of the layers of the multilayer structure is, in light of functions such as gas barrier properties and mechanical properties to be economically imparted, preferably 3 or more and 11 or less. Moreover, an average thickness of the multilayer structure is, in light of resource saving and handleability as a packaging material, preferably 20 μm or more and 500 μm or less, more preferably 30 μm or more and 200 μm or less, and still more preferably 75 μm or more and 160 μm or less.

Examples of the layer configuration of the multilayer structure of the present invention include the following configurations. It is to be noted that, as referred to herein, “/” denotes direct lamination, and “//” denotes direct lamination or lamination via the adhesive layer (C). Furthermore, “//” preferably denotes the lamination via the adhesive layer (C). Moreover, each layer may include a plurality of layers, and other layer(s) may be included.
PET layer//water-soluble layer (A)//PO layer (D)//barrier layer (E)//PO layer (D)
PET layer//water-soluble layer (A)//barrier layer (E)//PO layer (D)
PET layer/inorganic vapor deposition layer (I)//water-soluble layer (A)//PO layer (D)//barrier layer (E)//PO layer (D)
PET layer/inorganic vapor deposition layer (I)//water-soluble layer (A)//barrier layer (E)//PO layer (D)
PET layer/inorganic vapor deposition layer (I)//water-soluble layer (A)//PO layer (D)
PET layer//aluminum foil layer//water-soluble layer (A)//PO layer (D)//barrier layer (E)//PO layer (D)
PET layer//aluminum foil layer//water-soluble layer (A)//barrier layer (E)//PO layer (D)
PET layer//aluminum foil layer//water-soluble layer (A)//PO layer (D)
PET layer//water-soluble layer (A)//aluminum foil layer//PO layer (D)//barrier layer (E)//PO layer (D)
PET layer//water-soluble layer (A)//aluminum foil layer//barrier layer (E)//PO layer (D)
PET layer//water-soluble layer (A)//aluminum foil layer//PO layer (D)
PET layer//water-soluble layer (A)//inorganic vapor deposition layer (I)/barrier layer (E)//PO layer (D)
Aluminum foil layer//water-soluble layer (A)//PO layer (D)//barrier layer (E)//PO layer (D)
Aluminum foil layer//water-soluble layer (A)//barrier layer (E)//PO layer (D)
Aluminum foil layer//water-soluble layer (A)//PO layer (D)
PO layer//barrier layer//PO layer//water-soluble layer (A)//paper layer
PO layer//barrier layer//water-soluble layer (A)//paper layer

The multilayer structure of the present invention may include a plurality of water-soluble layers (A). In the multilayer structure of the present invention, dissolution of the water-soluble layer (A) in water results in separation into a plurality of layer structures. Of the plurality of layer structures, those including predefined layers and satisfying requirements on the predefined density as described above fall under the category of the layer structure (X) and the layer structure (Y). The layer structure (X) and the layer structure (Y) may each be present as one layer. The multilayer structure having a portion in which the layer structure (X) and the layer structure (Y) are laminated via a water-soluble layer (A) fall under the category of the multilayer structure of the present invention. When the layer structure (X) is denoted by X, the layer structure (Y) is denoted by Y, the water-soluble layer (A) is denoted by A, and the other layer structure(s) is/are denoted by Z, the layer configuration of the multilayer structure of the present invention including a plurality of water-soluble layers (A) may be exemplified as follows.
X/A/Y/A
X/A/Y/A/Z
Z/A/X/A/Y
Z/A/X/A/Y/A/Z

In other words, the multilayer structure of the present invention may be recognized to include a lamination configuration of “X/A/Y”. It is to be noted that, the other layer structure may satisfy the requirements for the layer structure (X) or the layer structure (Y). In other words, there may be a plurality of each of the layer structure (X) and the layer structure (Y). The multilayer structure of the present invention preferably includes only one water-soluble layer (A). In addition, the multilayer structure of the present invention preferably has the lamination configuration of “X/A/Y”.

The oxygen transmission rate of the multilayer structure of the present invention is not particularly limited and may be adjusted depending on the intended usage, and the oxygen transmission rate at a temperature of 20° C. and a relative humidity of 65% is preferably 10 cc/(m²·day·atm) or less, more preferably 1 cc/(m²·day·atm) or less, and still more preferably 0.1 cc/(m²·day·atm) or less. The multilayer structure having the oxygen transmission rate falling within this range is capable of inhibiting putrefaction and deterioration of contents, and thus maintaining the quality of the contents over a long time period. The oxygen transmission rate is measured in accordance with JIS K 7126-2 (Equal Pressure Method; 2006), and specifically, a procedure disclosed in EXAMPLES is adopted.

The moisture permeability of the multilayer structure of the present invention is not particularly limited and may be adjusted depending on the intended usage, and the moisture permeability at a temperature of 40° C. and a relative humidity of 90% is preferably 50 g/(m²·day) or less, more preferably 10 g/(m²·day) or less, and still more preferably 1 g/(m²·day) or less. The multilayer structure having the moisture permeability falling within this range is capable of inhibiting putrefaction and deterioration of contents, and thus maintaining the quality of the contents over a long time period. The moisture permeability is measured in accordance with JIS Z0208 (1976).

The multilayer structure of the present invention has a peeling percentage of preferably 70% or more, more preferably 80% or more, still more preferably 85% or more, and particularly preferably 90% or more or 95% or more, wherein the peeling percentage can be evaluated by: cutting out 100 regular tetragonal pieces of 1 cm×1 cm from the multilayer structure of the present invention; stirring them in pure water (water (W)) having a temperature of 80° C. for 60 min; and leaving the same to stand. The peeling percentage is expressed in terms of a rate (%) of the number of multilayer structures from which the layer structure (X) and the layer structure (Y) were peeled, with respect to 100 regular tetragonal multilayer structure pieces cut out into 1 cm×1 cm, and specifically, can be measured by the method described in EXAMPLES.

Moreover, to each layer of the multilayer structure of the present invention, for the purpose of improving molding processibility as well as a variety of physical properties, various types of the additives described above and/or a modification agent, a filler, an other resin, etc., may be added, within a range not leading to inhibition of the effects of the present invention.

### Method for Separation and Method for Recycling

The method for separating a multilayer structure of the present invention (separation step) includes a step of dissolving a part or all of the water-soluble layer (A) by bringing the multilayer structure of the present invention into contact with water (W) having a temperature of 20° C. to 95° C., and is accomplished by, in the step of dissolving, sedimenting the layer structure (X) and floating the layer structure (Y) in the water (W). Herein, with respect to “dissolving a part or all” as referred to, dissolving to the extent that the layer structure (X) and the layer structure (Y) were peeled is acceptable, but dissolving 75% by mass or more of the water-soluble layer (A) is preferred, dissolving 90% by mass or more of the water-soluble layer (A) is more preferred, and completely dissolving of the water-soluble layer (A) is still more preferred. According to the method for separating a multilayer structure of the present invention, an effect of eliminating attached contaminants and the like by elevating the temperature of water is expected, but on the other hand, there exists a possibility of a decrease in separation efficiency due to convection of the water, and the like. The size of the multilayer structure to be sunken into the water (W) is not particularly limited, and for promoting delamination in the case of the multilayer structure, the size is preferably smaller than 10 cm square. Additionally, immediately after sinking of the multilayer structure of the present invention, vigorous stirring to promote the delamination, followed by leaving to stand enables the separation to be achieved efficiently.

After completion of the separation, a sedimented layer structure (X) and a floating layer structure (Y) are each collected, washed with pure water, etc. as needed, dried, and thereafter melt molded by using an extruder, whereby repelletization as a recycled resin is enabled. By using thus obtained pellets, a variety of molded products may be produced, In other words, the method for recycling a multilayer structure of the present invention includes independently melt-molding each of the layer structure (X) and the layer structure (Y) collected in the method for separating a multilayer structure of the present invention.

It is to be noted that in the method for separating a multilayer structure of the present invention, the method for separation of the present invention involves also: a case in which the layer structure (X) and layer structure (Y) fail to completely peeled, whereby the layer structure (Y) is included in the collected layer structure (X) (in the sedimented matter) in part; and a case in which the layer structure (X) is included in the collected layer structure (Y) (in the floated matter) in part. In the method for separation of the present invention, the extent of separation of the layer structure (X) and the layer structure (Y) can be evaluated on the basis of a separation percentage, and specifically, the evaluation can be made by the method described in EXAMPLES. The separation percentage in the method for separation of the present invention is preferably 70% or more, more preferably 80% or more, still more preferably 90% or more, and particularly preferably 95% or more.

### Water (W)

The water (W) may be an aqueous solution containing, as a solute, a chloride salt such as sodium chloride or potassium chloride, and/or the like, or may be water (pure water) not containing a solute. A pH range of the water (W) is not particularly limited, but since equipment and/or a for dissolution and elimination can be significantly simplified, the pH of the water (W) preferably falls within the range of 5 to 9, may fall within the range of 6 to 8, or may fall within the range of 6.5 to 7.5. The water-soluble layer (A) included in the multilayer structure of the present invention is superior in solubility even in an approximately neutral pH region, e.g., pH 5 to 9, whereby easy dissolution and elimination is enabled. In light of economic efficiency and handleability in the step of collecting the film separated, the water (W) is preferably pure water.

Flotation or sedimentation of the film (the layer structure) in the water (W) after elimination of the water-soluble layer (A) depends on relative specific gravity of the film and the water (W). In a case of a substance having a specific gravity of 1 or more, such as a polyester or an ethylene-vinyl alcohol copolymer, a behavior of sedimentation in common water is found; however, in a case in which collection through flotation is preferred, an increase in the specific gravity of the water (W) by addition of a chloride salt such as sodium chloride, potassium chloride, or calcium chloride to the water (W) enables the collection through flotation. In this case, in light of economic efficiency and handleability, a concentration of the chloride salt or the like needed for attaining a necessary specific gravity of the water (W) is preferably 40% by mass or less. In the case in which the concentration is 40% by mass or less, a cost for providing the chloride salt or the like can be saved, and a washing step after the separation can be efficiently carried out.

Furthermore, in light of stability of the separating step, the concentration of the chloride salt or the like needed for attaining a necessary specific gravity of the water (W) is preferably less than a concentration of a saturated solution of the chloride salt or the like by 10% by mass or more. In the case in which the difference between the concentration of the saturated solution of the chloride salt or the like, and the concentration of the chloride salt or the like needed for attaining a necessary specific gravity of the water (W) is 10% by mass or more, the chloride salt or the like can be dissolved within a comparatively short time period, and deposition of the chloride salt or the like onto a separation bath and/or the substances after the separation may be inhibited, whereby stability of the step may be improved.

The specific gravity of the water (W) is preferably between the specific gravity of the layer structure (X) and the specific gravity of the layer structure (Y), in light of making the peelability in the separation step favorable. Due to the specific gravity of the water (W) being between the specific gravity of the layer structure (X) and the specific gravity of the layer structure (Y), when the layer structure (X) and the layer structure (Y) are peeled after dissolution and elimination of a part of the water-soluble layer (A), an influence on the peelability by the flotation/sedimentation difference, resulting from the specific gravity difference (the density difference) between the layer structure (X) and the layer structure (Y), tends to be markedly exhibited, and handleability in the collecting step after separation is improved.

A packaging material constituted from the multilayer structure of the present invention is a suitable embodiment of the present invention. The packaging material is processed into a form being tubular, pouched, or the like, to be useful as various types of packaging materials, for e.g., foods, beverages, medical drugs, cosmetics, industrial chemicals, pesticides, detergents, and the like, and thus can be used for a wide range of intended usage, but is not limited thereto.

### EXAMPLES

Hereinafter, the present invention is further specifically described by way of Examples, but the present invention is not in any way limited to these Examples.

### Example 1

### (1) Production of Pelletized EVOH Resin Composition

EVOH-38 (ethylene content: 38 mol %, degree of saponification: 99.6 mol %, MFR (at 190° C., under 2.16 kg load): 1.69 g/10 min, density: 1.2 g/cm³, oxygen transmission rate (under conditions of 20° C. and 65% RH): 0.71 cc·20 μm/(m²·day·atm), containing sodium acetate in terms of sodium ion equivalent being 250 ppm, phosphoric acid in terms of phosphoric acid ion equivalent being 90 ppm, and orthoboric acid as a boron compound in terms of boron element equivalent being 180 ppm) were melt-kneaded, whereby a pelletized EVOH resin composition was obtained. The melt-kneading was conducted by using a 25 mm extruder manufactured by Toyo Seiki Seisaku-sho, Ltd., (D (mm)=25, L/D=30, screw: fully intermeshing co-rotation type), such that a resin temperature became 220)° C.

### (2) Production of Pelletized PVA Resin Composition

PVA having a viscosity-average degree of polymerization of 800, a degree of saponification of 88 mol %, and a sum of contents of a vinyl alcohol unit and a vinyl acetate unit with respect to total monomer units being 99.9 mol % was obtained by polymerizing vinyl acetate according to a common procedure, and saponifying a thus resulting vinyl acetate polymer according to a common procedure. After mixing 87 parts by mass of the PVA thus obtained and 13 parts by mass of glycerin as a plasticizer by using a planetary mixer, an aqueous sodium acetate solution was added thereto such that a content of a sodium ion (alkali metal ion (a2)) became 800 ppm, and then melt kneading was conducted to give a pelletized PVA resin composition. The melt kneading was conducted by using a 25 mm extruder manufactured by Toyo Seiki Seisaku-sho, Ltd., (D (mm)=25, L/D=30, screw: fully intermeshing co-rotation type), such that a resin temperature became 220° C. It is to be noted that the viscosity-average degree of polymerization and the degree of saponification of the PVA obtained were determined in accordance with the methods described in JIS K6726 (1994).

### (3) Production of Coating Liquid

To 10 parts by mass of the pelletized PVA resin composition obtained in (2) above were added 90 parts by mass of distilled water, and the temperature of the mixture was elevated to 80° C. with stirring, whereby a PVA coating liquid was obtained.

(4) Production of Laminate of Layer Structure (X) and Water-Soluble layer (A)

As the substrate layer (B), a PET film (“Toyobo Ester (trademark) E5101”, manufactured by Toyobo Co., Ltd.; density: 1.38 g/cm³) having an average thickness of 100 μm was provided. An anchor coating agent was applied on this substrate layer (B) using a bar coater, such that the average thickness after drying became 80 nm. As the anchor coating agent, two-component adhesives (“TAKELAC (trademark) A-626”, manufactured by Mitsui Chemicals, Inc. Co. Ltd.; and “TAKENATE (trademark) A-50”, manufactured by Mitsui Chemicals. Inc. Co. Ltd.) were employed. The film after applying was dried at 80° C, for 2 min to form an adhesive layer (C) on the PET layer (substrate layer (B)), whereby a layer structure (X) was produced. The density of the layer structure (X) was measured using a dry automatic densitometer (“AccuPyc 1330)”, manufactured by Shimadzu Corporation), and revealed to be 1.38 g/cm³. Subsequently, the PVA coating liquid obtained in (3) above was applied on the adhesive layer (C) using a bar coater such that the average thickness after drying became 4 μm. The film after applying was dried at 100° C. for 3 min, to form a water-soluble layer (A) on the adhesive layer (C) of the layer structure (X). Accordingly, a “laminate in which the water-soluble layer (A) was laminated on the layer structure (X)” was obtained, having a configuration of: the substrate layer (B)/the adhesive layer (C)/the water-soluble layer (A) (PET layer/anchor coating layer/PVA resin composition layer).

### (5) Production of Layer Structure (Y)

By using an apparatus for forming a coextruded-multilayer cast film, a layer structure (Y) (a five layer-coextruded multilayer cast film having a layer thickness (average thickness) and a layer configuration of: an LDPE layer/a maleic anhydride-modified polyethylene layer/an EVOH resin composition layer/a maleic anhydride-modified polyethylene layer/the LDPE layer =PO layer (D)/the adhesive layer (C)/the barrier layer (E)/the adhesive layer (C)/the PO layer (D)=21 μm/2 μm/2 μm/2 μm/21 μm) was formed to give a film, in which the PO layer (D) was constituted from low-density polyethylene (LDPE; “Novatec (trademark) LJ400”, manufactured by Japan Polyethylene Corporation; density: 0.92 g/cm³), the barrier layer (E) was constituted from EVOH resin composition obtained in (1) above, and the adhesive layer (C) was constituted from maleic anhydride-modified polyethylene (“Admer (trademark) NF518”, manufactured by Mitsui Chemicals, Inc.; density: 0.91 g/cm³). Conditions for film formation in this procedure are shown below. The density of the layer structure (Y) was measured using a dry automatic densitometer (“AccuPyc 1330”, manufactured by Shimadzu Corporation), and revealed to be 0.95 g/cm³.

### Coextrusion Conditions

extrusion temperature of the PO layer (D): feeding zone/compression zone/metering zone/die=170/210/210/210° C.
extrusion temperature of the barrier layer (E): feeding zone/compression zone/metering zone/die=170/210/210/210° C.
extrusion temperature of the adhesive layer (C): feeding zone/compression zone/metering zone/die =170/210/210/210° C.

### Extruder

32φ extruder for the PO layer (D), model GT-32-A (manufactured by Research Laboratory of Plastics Technology Co., Ltd.)
20φ extruder for the barrier layer (E), laboratory-type ME Model CO-EXT (manufactured by Toyo Seiki Seisaku-sho, Ltd.)
25φextruder for the adhesive layer (C), model P25-18-AC (manufactured by OSAKA SEIKI KOSAKU Co., Ltd.)
T-die: width=300 mm for five layers each selected from three types (manufactured by Research Laboratory of Plastics Technology Co., Ltd.)
temperature of cooling rolls: 80° C.
drawing speed: 3.0 m/min

### (6) Hydrophilic Treatment

Onto one surface of the layer structure (Y′) produced in (5) above, a hydrophilic treatment was carried out by using the following apparatus. The table speed scale and the output presetting of high-frequency power supply were adjusted such that the hydrophilic treatment strength became 130 W·min/m².

Apparatus: Corona treatment equipment TEC-4AC, manufactured by KASUGA DENKI, Inc.

### (7) Production of Multilayer Structure

The “laminate in which the water-soluble layer (A) was laminated on the layer structure (X)” obtained in (4) above, and the layer structure (Y″) subjected to the hydrophilic treatment on one face thereof obtained in (6) above were each cut away to give a size of A4. An adhesive for dry lamination was applied on the face, which had been subjected to the hydrophilic treatment, of the layer structure (Y″), then the layer structure (X) and the layer structure (Y′) were laminated by dry lamination such that the configuration became: the layer structure (X)/the water-soluble layer (A)/the adhesive layer (C)/the layer structure (Y′) (PET layer/anchor coating layer/PVA resin composition layer/dry laminate layer/LDPE layer (surface-treated)/maleic anhydride-modified polyethylene layer/EVOH resin composition layer/maleic anhydride-modified polyethylene layer/LDPE layer), followed by drying at 80° C. for 3 min to give a multilayer structure (laminated film). As the adhesive for dry lamination, two-component adhesives (“TAKELAC-520)”, available from Mitsui Chemicals, Inc. Co. Ltd.; and “TAKENATE-50)” available from Mitsui Chemicals, Inc. Co. Ltd.) were employed. The amount of the adhesive to be applied was set to be 4.0 g/m², and lamination was followed by aging carried out at 40° C. for 3 days to give a laminated film.

It is to be noted that a portion being “the adhesive layer (C)/the layer structure (Y′)” (dry laminate layer/LDPE layer (surface-treated)/maleic anhydride-modified polyethylene layer/EVOH resin composition layer/maleic anhydride-modified polyethylene layer/LDPE layer) in the multilayer structure thus obtained corresponds to the layer structure (Y). In other words, the multilayer structure obtained had a layer configuration of “the layer structure (X)/the water-soluble layer (A)/the layer structure (Y)”. Since the adhesive layer (C) provided for dry lamination was very thin as compared to the layer structure (Y″), the density of the layer structure (Y) was 0.95 g/cm³, being the same as the density of the layer structure (Y′). Also in other Examples 2 to 17 and Comparative Examples 1 to 5 described later, the density of the layer structure (Y) was equal to the density of the layer structure (Y′) before providing the adhesive layer (C) for dry lamination.

### (8) Evaluation of Interlayer Adhesiveness Under High Humidity

As a marker of interlayer adhesiveness between the layer structure (X) and the layer structure (Y) in the multilayer structure produced in (7) above, an adhesion strength was measured under high humidity conditions, i.e., the following conditions. After the multilayer structure was subjected to moisture conditioning in an atmosphere of 20° C. and 90% RH for 7 days, a strip test piece of 15 mm×200 mm was cut out. With respect to the test piece thus obtained, a T-type peel strength (gf/15 mm) was measured with “model AGS-H”, an autograph manufactured by Shimadzu Corporation, under a condition involving a distance between chucks of 50 mm and a strain rate of 250 mm/min. The measurement was carried out on five test pieces, and an averaged value therefrom was defined as the “adhesion strength”. Criteria for the evaluation were as in the following. The results are shown in Table 1.
A: the adhesion strength being 100 gf/15 mm or more
B: the adhesion strength being 50 gf/15 mm or more and less than 100 gf/15 mm
C: the adhesion strength being 25 gf/15 mm or more and less than 50 gf/15 mm
D: the adhesion strength being less than 25 gf/15 mm

### (9) Evaluation of Peelability, Separability

### (9-1) Evaluation of Peelability of Layer Structure (X) and Layer Structure (Y)

The multilayer structure produced in (7) above was colored with a blue permanent marker on an exposed surface of the PET layer on the layer structure (X) side, and with a red permanent marker on an exposed surface of the LDPE layer on the layer structure (Y) side, and thereafter, cut out into 100 regular tetragonal pieces of 1 cm×1 cm therefrom to give test pieces. The test pieces thus obtained were evaluated on peelability by stirring in pure water (water (W)) having a temperature of 80° C. for 60 min, followed by leaving to stand still. The peeling percentage (%) was defined as a rate of the number of the multilayer structures from which the layer structure (X) and the layer structure (Y) were peeled, with respect to the 100 test pieces, and assessment criteria of the peelability were as described below. The occurrence of peeling was assessed by visual inspections of the color of film pieces. The film pieces after completion of the peeling are observed to be each blue or red in color, whereas the film pieces not peeled are observed to be purple in color. The results are shown in Table 1.
A: the peeling percentage after leaving to stand still for 5 min being 95% or more
B: the peeling percentage after leaving to stand still for 5 min being 90% or more and less than 95%
C: the peeling percentage after leaving to stand still for 5 min being 80% or more and less than 90%
D: the peeling percentage after leaving to stand still for 5 min being 70% or more and less than 80%
E: the peeling percentage after leaving to stand still for 5 min being less than 70%

### (9-2) Evaluation of Separability

Test pieces were produced and tested similarly to (9-1). After testing, separability of the layer structure (X) and the layer structure (Y), i.e., a possibility of separation through sedimentation of one of both layer structures and flotation of another layer structure, was evaluated with the following assessment criteria by leaving the test pieces to stand still. The results are shown in Table 1.
A: the separation percentage after leaving to stand still for 5 min being 95% or more
B: the separation percentage after leaving to stand still for 5 min being 90% or more and less than 95%
C: the separation percentage after leaving to stand still for 5 min being 80% or more and less than 90%
D: the separation percentage after leaving to stand still for 5 min being less than 80%

### (10) Evaluation of Oxygen Barrier Property (OTR)

The layer structure (X), the layer structure (Y′), and the multilayer structure obtained in (4), (5), and (7) above were subjected to humidity conditioning for 24 hrs under conditions involving a temperature of 20° C. and a relative humidity of 65%. Thereafter, an oxygen transmission rate (cc/(m²·day·atm)) was measured under the same conditions in accordance with a method described in JIS K7126-2 (equal pressure method; 2006), by using an oxygen transmission rate meter “OX-TRANMODEL 2/21” manufactured by Mocon Inc. It is to be noted that the OTR of the layer structure (Y) was confirmed to be equal to the OTR of the layer structure (Y″) before providing the adhesive layer (C) for dry lamination. Also in other Examples 2 to 17 and Comparative Examples 1 to 5 described later, the OTR of the layer structure (Y) was equal to the OTR of the layer structure (Y″). The oxygen barrier property of the multilayer structure was evaluated according to the following criteria. The results are shown in Table 1.
A: the oxygen transmission rate being less than 3 cc/(m²·day·atm)
B: the oxygen transmission rate being 3 cc/(m²·day·atm) or more and less than 7.5 cc/(m²·day·atm)
C: the oxygen transmission rate being 7.5 cc/(m²·day·atm) or more and less than 15 cc/(m²·day·atm)
D: the oxygen transmission rate being 15 cc/(m²·day·atm) or more

### Example 2

A pelletized PVA resin composition was produced in a similar manner to Example 1, except that: a blend, at a mass ratio of 70/30, containing a PVA having a viscosity-average degree of polymerization being 600, a degree of saponification being 80 mol %, and a sum of contents of the vinyl alcohol unit and the vinyl acetate unit with respect to total monomer units being 99.9 mol %, and a PVA having a viscosity-average degree of polymerization being 800, a degree of saponification being 74 mol %, and a sum of contents of the vinyl alcohol unit and the vinyl acetate unit with respect to total monomer units being 99.9 mol % was used as the hydroxyl group-containing resin (a1); and without adding the plasticizer (glycerin), an aqueous sodium acetate solution was added such that the content of sodium ion (alkali metal ion (a2)) became 400 ppm, and then the layer structure (X) and the like and the multilayer structure were produced and evaluated. The results are shown in Table 1.

### Examples 3 to 5

A pelletized PVA resin composition was produced in a similar manner to Example 1, except that a plasticizer shown in Table I was added in place of glycerin, and then the layer structure (X) and the like and the multilayer structure were produced and evaluated. It is to be noted that PEG used in Example 3 was “CARBOWAX” 1000 manufactured by Dow Ltd., (molecular weight: 1,000). The results are shown in Table 1.

### Examples 6 to 9

A pelletized PVA resin composition was produced in a similar manner to Example 1, except that the addition amount of the aqueous sodium acetate solution was changed such that the content of sodium ion (alkali metal ion (a2)) became as shown in Tables 1 and 2, and then the layer structure (X) and the like and the multilayer structure were produced and evaluated. The results are shown in Tables 1 and 2.

### Example 10

A pelletized PVA resin composition was produced in a similar manner to Example 1, except that as the hydroxyl group-containing resin (a1), a PVA having a viscosity-average degree of polymerization being 350, a degree of saponification being 88 mol %, and a sum of contents of the vinyl alcohol unit and the vinyl acetate unit with respect to total monomer units being 99.9 mol % was used, and then the layer structure (X) and the like and the multilayer structure were produced and evaluated. The results are shown in Table 2.

### Example 11

A pelletized PVA resin composition was produced in a similar manner to Example 1, except that an aqueous potassium acetate solution was used in place of the aqueous sodium acetate solution, and then the layer structure (X) and the like and the multilayer structure were produced and evaluated. The results are shown in Table 2.

### Example 12

A pelletized PVA resin composition was produced in a similar manner to Example 1, except that: as the hydroxyl group-containing resin (a1), an ethylene modified PVA having a degree of modification with ethylene being 8 mol %, a viscosity-average degree of polymerization being 350, a degree of saponification being 98 mol %, and a sum of contents of the vinyl alcohol unit and the vinyl acetate unit with respect to total monomer units being 92 mol % was used; and glycerin was not added, and then the layer structure (X) and the like and the multilayer structure were produced and evaluated. The results are shown in Table 2.

### Example 13

The layer structure (X) and the like and the multilayer structure were produced and evaluated in a similar manner to Example 1, except that: as the barrier layer (E), nylon MXD6 (manufactured by Mitsubishi Gas Chemical Company, Inc., “S6007”, density: 1.2 g/cm³) was used; the coextrusion temperature was changed as follows; and the average thickness of the barrier layer (E) was changed to 10 μm. The results are shown in Table 3.

### Coextrusion Conditions

extrusion temperature of the adhesive layer (C): feeding zone/compression zone/metering zone/die =200/250/250/250° C.
extrusion temperature of the PO layer (D): feeding zone/compression zone/metering zone/die =200/250/250/250° C.
extrusion temperature of the barrier layer (E): feeding zone/compression zone/metering zone/die =220/250/250/250° C.

### Example 14

A pelletized EVOH resin composition was produced in a similar manner to Example 1, except that: EVOH-48 (ethylene content: 48 mol %, degree of saponification: 99.6 mol %, MFR (at 190° C., under 2.16 kg load): 6.40 g/10 min, density: 1.1 g/cm³, oxygen transmission rate (under conditions of 20° C. and 65% RH): 3.5 cc·20 μm/(m2· day atm), containing sodium acetate in terms of sodium ion equivalent being 200 ppm, phosphoric acid in terms of phosphoric acid ion equivalent being 120 ppm, and orthoboric acid as a boron compound in terms of boron element equivalent being 150 ppm) was used as the EVOH resin composition, and then the layer structure (X) and the like and the multilayer structure were produced and evaluated. The results are shown in Table 3.

### Example 15

The layer structure and the like and the multilayer structure were produced and evaluated in a similar manner to Example 1, except that as the PO layer (D), high-density polyethylene (HDPE; manufactured by Japan Polyethylene Corporation “Novatec (trademark) HD HY331”, density: 0.95 g/cm³) was used in place of LDPE. The results are shown in Table 3.

### Example 16

The layer structure (X) and the like and the multilayer structure were produced and evaluated in a similar manner to Example 1, except that without providing the anchor coating layer on the layer structure (X), just the PET film was used as the layer structure (X). The results are shown in Table 3.

### Example 17

The layer structure (X) and the like and the multilayer structure were produced and evaluated in a similar manner to Example 1, except that: in place of the PET film (the substrate layer (B)), a transparent vapor deposited PET film (a laminate of the substrate layer (B) and the inorganic vapor deposition layer (I)) obtained by providing an alumina vapor deposition layer having an average thickness of 50 nm on one face of a PET film (manufactured by Toyobo Co., Ltd., “Toyobo Ester (trademark) E5101”, density: 1.38 g/cm³) having an average thickness of 100 μm with a well-known vacuum deposition process was used; and anchor coating agent was applied on the alumina vapor deposition layer. The results are shown in Table 3.

### Example 18

By using an apparatus for forming a coextruded-multilayer cast film, a multilayer structure (a nine layer-coextruded multilayer cast film having a width of 300 mm, and a layer thickness (average thickness) and a layer configuration of: ((B)/(C1)/(A)/(C2)/(D)/(C2)/(E)/(C2)/(D)=a PET layer/a maleic anhydride-modified ethylene acrylate copolymer layer/a PVA resin composition layer/a maleic anhydride-modified polyethylene layer/an LDPE layer/a maleic anhydride-modified polyethylene layer/an EVOH resin composition layer/a maleic anhydride-modified polyethylene layer/an LDPE layer=100 μm/2 μm/4 μm/2 μm/21 μm/2 μm/2 μm/2 μm/21 μm) was produced, in which the water-soluble layer (A) was constituted from the pelletized PVA resin composition obtained in Example 1, the substrate layer (B) was constituted from polyethylene terephthalate (PET; manufactured by Bell Polyester Products, Inc. “BELLPET EFG70”, the adhesive layer (C1) was constituted from a maleic anhydride-modified ethylene acrylate copolymer (manufactured by Dow Chemical Ltd., “Bynel 21E533”, the PO layer (D) was constituted from low-density polyethylene (LDPE; manufactured by Japan Polyethylene Corporation “Novatec (trademark) LJ400”), the barrier layer (E) was constituted from the EVOH resin composition obtained in Example 1, and the adhesive layer (C2) was constituted from maleic anhydride-modified polyethylene (manufactured by Mitsui Chemicals, Inc., “Admer (trademark) NF518”), and then evaluated in a similar manner to Example 1. The results are shown in Table 3. The density of the layer structure (X) and the layer structure (Y) was measured by: film formation of each of the layer structure (X) (the PET layer/the maleic anhydride-modified ethylene acrylate layer=100 μm/2 μm) and the layer structure (Y) (the maleic anhydride-modified polyethylene layer/the LDPE layer/the maleic anhydride-modified polyethylene layer/the EVOH resin composition layer/the maleic anhydride-modified polyethylene layer/the LDPE layer=2 μm/21 μm/2 μm/2 μm/2 μm/21 μm); and using a dry automatic densitometer (manufactured by Shimadzu Corporation “AccuPyc 1330”). The density of the layer structure (X) was 1.38 g/cm³, and the density of the layer structure (Y) was 0.95 g/cm³.

### Comparative Example 1

The layer structure (X) and the like and the multilayer structure (the PET layer/the dry laminate layer/the LDPE layer (surface-treated)/the maleic anhydride-modified polyethylene layer/the EVOH resin composition layer/the maleic anhydride-modified polyethylene layer/the LDPE layer) were prepared or produced and evaluated in a similar manner to Example 1, except that the anchor coating layer (adhesive layer (C)) of the water-soluble layer (A) and the layer structure (X) was not provided. The results are shown in Table 4.

### Comparative Example 2, Comparative Example 3

A pelletized PVA resin composition was produced in a similar manner to Example 1, except that: the addition amount of the aqueous sodium acetate solution was changed such that the content of sodium ion (alkali metal ion (a2)) became as shown in Table 4, and then the layer structure (X) and the like and the multilayer structure were produced and evaluated. The results are shown in Table 4.

### Comparative Example 4

The layer structure (X) and the like and the multilayer structure were produced and evaluated in a similar manner to Example 1, except that: as the barrier layer (E), polyamide 6/66 (manufactured by BASF Ltd., “Ultramid C40L”, density: 1.1 g/cm³) was used; the coextrusion temperature was changed as shown below; and the average thickness of the barrier layer (E) was changed to 25 μm. The results are shown in Table 4.

### Coextrusion Conditions

extrusion temperature of the adhesive layer (C): feeding zone/compression zone/metering zone/die=170/210/210/220° C.
extrusion temperature of the PO layer (D): feeding zone/compression zone/metering zone/die=170/210/210/220° C.
extrusion temperature of the barrier layer (E): feeding zone/compression zone/metering zone/die=200/220/220/220° C.

### Comparative Example 5

The layer structure (X) and the like and the multilayer structure were produced and evaluated in a similar manner to Example 1, except that as the substrate layer (B), a monolayer film constituted from polyamide 12 produced by the following method was used in place of the PET film. The results are shown in Table 4.

The monolayer film constituted from polyamide 12 was obtained by performing monolayer film formation using polyamide 12 (manufactured by Ube Industries, Ltd. “UBESTA 3030XA”, density: 1.01 g/cm³), with a 20 mm extruder “D2020” manufactured by Seiki Seisaku-sho, Ltd., (D (mm)=20, L/D =20, compression ratio=2.0, screw: full flight) under the following conditions.
cylinder temperature: feeding zone at 215° C., compression zone at 230° C., metering zone at 230° C.
die temperature: 230° C.
screw rotation speed: 100 rpm
temperature of drawing rolls: 80° C.
roll drawing speed: 1.5 m/min
film average thickness: 100 μm

Onto one surface of the film obtained, the hydrophilic treatment was carried out by using the apparatus described above, whereby the substrate layer (B) constituted from polyamide 12 was obtained.

TABLE 1

| | | | Exam- | Exam- | Exam- | Exam- | Exam- | Exam- |
|---|---|---|---|---|---|---|---|---|
| | | | ple 1 | ple 2 | ple 3 | ple 4 | ple 5 | ple 6 |
| Water- | hydroxyl group- | type | PVA | PVA | PVA | PVA | PVA | PVA |
| soluble | containing | viscosity-average | 800 | 600/800 | 800 | 800 | 800 | 800 |
| layer | resin (a1) | degree of | | | | | | |
| (A) | | polymerization | | | | | | |
| | | degree of | 88 | 80/74 | 88 | 88 | 88 | 88 |
| | | saponification | | | | | | |
| | | [mol%] | | | | | | |
| | alkali metal | type | Na | Na | Na | Na | Na | Na |
| | ion (a2) | content [ppm] | 800 | 400 | 800 | 800 | 800 | 400 |
| | plasticizer | type | glycerin | — | PEG | mannitol | sorbitol | glycerin |
| | (a3) | content [mass %] | 13 | — | 13 | 13 | 13 | 13 |
| Layer | substrate | Type | PET | PET | PET | PET | PET | PET |
| structure | layer (B) | | | | | | | |
| (X) | inorganic vapor | type | — | — | — | — | — | — |
| | deposition layer | | | | | | | |
| | (I) | | | | | | | |
| | adhesive | type | anchor | anchor | anchor | anchor | anchor | anchor |
| | layer (C) | | coating | coating | coating | coating | coating | coating |
| | | | agent | agent | agent | agent | agent | agent |
| | density [g/cm³] | | 1.38 | 1.38 | 1.38 | 1.38 | 1.38 | 1.38 |
| | oxygen transmission rate | | 25 | 25 | 25 | 25 | 25 | 25 |
| | [cc/m² · day · atm] | | | | | | | |
| Layer | PO layer (D) | type | LDPE | LDPE | LDPE | LDPE | LDPE | LDPE |
| structure | barrier layer (E) | Type | EVOH-38 | EVOH-38 | EVOH-38 | EVOH-38 | EVOH-38 | EVOH-38 |
| (Y) | density [g/cm³] | | 0.95 | 0.95 | 0.95 | 0.95 | 0.95 | 0.95 |
| | oxygen transmission rate | | 7.5 | 7.5 | 7.5 | 7.5 | 7.5 | 7.5 |
| | [cc/m² · day · atm] | | | | | | | |
| density difference between layer structure (X) | | | 0.43 | 0.43 | 0.43 | 0.43 | 0.43 | 0.43 |
| and layer structure (Y) [g/cm³] | | | | | | | | |
| Evaluation | interlayer adhesiveness | | A | B | A | A | A | A |
| of | (under high humidity condition) | | | | | | | |
| characteristics | peelability of layer | peeling | 99 | 91 | 93 | 95 | 96 | 98 |
| | structure (X) and | percentage (%) | | | | | | |
| | layer structure (Y) | evaluation | A | B | B | A | A | A |
| | separability of layer | separation | 99 | 98 | 98 | 98 | 98 | 99 |
| | structure (X) and | percentage (%) | | | | | | |
| | layer structure (Y) | evaluation | A | A | A | A | A | A |

| | | | | | | |
|---|---|---|---|---|---|---|
| oxygen barrier property | B | B | B | B | B | B |

TABLE 2

| | | | Exam- | Exam- | Exam- | Exam- | Exam- | Exam- |
|---|---|---|---|---|---|---|---|---|
| | | | ple 7 | ple 8 | ple 9 | ple 10 | ple 11 | ple 12 |
| Water- | hydroxyl group- | type | PVA | PVA | PVA | PVA | PVA | ethylene- |
| soluble | containing | | | | | | | modified |
| layer | resin (a1) | | | | | | | PVA |
| (A) | | viscosity-average | 800 | 800 | 800 | 350 | 800 | 350 |
| | | degree of | | | | | | |
| | | polymerization | | | | | | |
| | | degree of | 88 | 88 | 88 | 88 | 88 | 98 |
| | | saponification | | | | | | |
| | | [mol%] | | | | | | |
| | alkali metal | type | Na | Na | Na | Na | K | Na |
| | ion (a2) | content [ppm] | 200 | 50 | 1600 | 800 | 800 | 400 |
| | plasticizer | type | glycerin | glycerin | glycerin | glycerin | glycerin | — |
| | (a3) | content [mass %] | 13 | 13 | 13 | 13 | 13 | — |
| Layer | substrate | type | PET | PET | PET | PET | PET | PET |
| structure | layer (B) | | | | | | | |
| (X) | inorganic vapor | type | — | — | — | — | — | — |
| | deposition layer | | | | | | | |
| | (I) | | | | | | | |
| | adhesive | type | anchor | anchor | anchor | anchor | anchor | anchor |
| | layer (C) | | coating | coating | coating | coating | coating | coating |
| | | | agent | agent | agent | agent | agent | agent |
| | density [g/cm³] | | 1.38 | 1.38 | 1.38 | 1.38 | 1.38 | 1.38 |
| | oxygen transmission rate | | 25 | 25 | 25 | 25 | 25 | 25 |
| | [cc/m² · day · atm] | | | | | | | |
| layer | PO layer (D) | type | LDPE | LDPE | LDPE | LDPE | LDPE | LDPE |
| structure | barrier layer (E) | type | EVOH-38 | EVOH-38 | EVOH-38 | EVOH-38 | EVOH-38 | EVOH-38 |
| (Y) | density [g/cm³] | | 0.95 | 0.95 | 0.95 | 0.95 | 0.95 | 0.95 |
| | oxygen transmission rate | | 7.5 | 7.5 | 7.5 | 7.5 | 7.5 | 7.5 |
| | [cc/m² · day · atm] | | | | | | | |
| density difference between the layer structure (X) | | | 0.43 | 0.43 | 0.43 | 0.43 | 0.43 | 0.43 |
| and the layer structure (Y)[g/cm³] | | | | | | | | |
| Evaluation | interlayer adhesiveness | | A | B | C | B | A | B |
| of | (under high humidity condition) | | | | | | | |
| Characteristics | peelability of layer | peeling | 92 | 85 | 99 | 99 | 99 | 86 |
| | structure (X) and | percentage (%) | | | | | | |
| | layer structure (Y) | evaluation | B | C | A | A | A | C |
| | separability of layer | separation | 99 | 99 | 99 | 99 | 99 | 99 |
| | structure (X) and | percentage (%) | | | | | | |
| | layer structure (Y) | evaluation | A | A | A | A | A | A |

| | | | | | | |
|---|---|---|---|---|---|---|
| oxygen barrier property | B | B | B | B | B | B |

TABLE 3

| | | | Exam- | Exam- | Exam- | Exam- | Exam- | Exam- |
|---|---|---|---|---|---|---|---|---|
| | | | ple 13 | ple 14 | ple 15 | ple 16 | ple 17 | ple 18 |
| Water- | hydroxyl group- | type | PVA | PVA | PVA | PVA | PVA | PVA |
| soluble | containing | viscosity-average | 800 | 800 | 800 | 800 | 800 | 800 |
| layer | resin (a1) | degree of | | | | | | |
| (A) | | polymerization | | | | | | |
| | | degree of | 88 | 88 | 88 | 88 | 88 | 88 |
| | | saponification | | | | | | |
| | | [mol%] | | | | | | |
| | alkali metal | type | Na | Na | Na | Na | Na | Na |
| | ion (a2) | content [ppm] | 800 | 800 | 800 | 800 | 800 | 800 |
| | plasticizer | type | glycerin | glycerin | glycerin | glycerin | glycerin | glycerin |
| | (a3) | content [mass %] | 13 | 13 | 13 | 13 | 13 | 13 |
| Layer | substrate | type | PET | PET | PET | PET | PET | PET |
| structure | layer (B) | | | | | | | |
| (X) | inorganic vapor | type | — | — | — | — | alumina | — |
| | deposition layer | | | | | | | |
| | (I) | | | | | | | |
| | adhesive | type | anchor | anchor | anchor | — | anchor | modified |
| | layer (C) | | coating | coating | coating | | coating | ethylene |
| | | | agent | agent | agent | | agent | acrylate |
| | | | | | | | | copolymer |
| | density [g/cm³] | | 1.38 | 1.38 | 1.38 | 1.38 | 1.38 | 1.38 |
| | oxygen transmission rate | | 25 | 25 | 25 | 25 | 1 | 25 |
| | [cc/m² · day · atm] | | | | | | | |
| Layer | PO layer (D) | type | LDPE | LDPE | HDPE | LDPE | LDPE | LDPE |
| structure | barrier layer (E) | type | MXD6 | EVOH-48 | EVOH-38 | EVOH-38 | — | EVOH-38 |
| (Y) | density [g/cm³] | | 0.97 | 0.94 | 0.96 | 0.95 | 0.92 | 0.95 |
| | oxygen transmission rate | | 12 | 15 | 7.5 | 7.5 | >200 | 7.5 |
| | [cc/m² · day · atm] | | | | | | | |
| density difference between the layer structure (X) | | | 0.41 | 0.44 | 0.42 | 0.43 | 0.46 | 0.43 |
| and the layer structure (Y)[g/cm³] | | | | | | | | |
| Evaluation | interlayer adhesiveness | | A | A | A | C | A | A |
| of | (under high humidity condition) | | | | | | | |
| Characteristics | peelability of layer | peeling | 98 | 99 | 97 | 99 | 99 | 98 |
| | structure (X) and | percentage (%) | | | | | | |
| | layer structure (Y) | evaluation | A | A | A | A | A | A |
| | separability of layer | separation | 96 | 99 | 98 | 99 | 99 | 99 |
| | structure (X) and | percentage (%) | | | | | | |
| | layer structure (Y) | evaluation | A | A | A | A | A | A |

| | | | | | | |
|---|---|---|---|---|---|---|
| oxygen barrier property | C | C | B | B | A | B |

TABLE 4

| | | | Comparative | Comparative | Comparative | Comparative | Comparative |
|---|---|---|---|---|---|---|---|
| | | | Example 1 | Example 2 | Example 3 | Example 4 | Example 5 |
| Water- | hydroxyl group- | type | — | PVA | PVA | PVA | PVA |
| soluble | containing | viscosity-average | — | 800 | 800 | 800 | 800 |
| layer | resin (a1) | degree of | | | | | |
| (A) | | polymerization | | | | | |
| | | degree of | — | 88 | 88 | 88 | 88 |
| | | saponification | | | | | |
| | | [mol%] | | | | | |
| | alkali metal | type | — | Na | Na | Na | Na |
| | ion (a2) | content [ppm] | — | 5 | 4,000 | 800 | 800 |
| | plasticizer | type | — | glycerin | glycerin | glycerin | glycerin |
| | (a3) | content [mass %] | — | 13 | 13 | 13 | 13 |
| Layer | substrate | type | PET | PET | PET | PET | PA12 |
| structure | layer (B) | | | | | | |
| (X) | inorganic vapor | type | — | — | — | — | — |
| | deposition layer | | | | | | |
| | (I) | | | | | | |
| | adhesive | type | — | — | anchor | anchor | anchor |
| | layer (C) | | | | coating | coating | coating |
| | | | | | agent | agent | agent |
| | density [g/cm³] | | 1.38 | 1.38 | 1.38 | 1.38 | 1.01 |
| | oxygen transmission rate | | 25 | 25 | 25 | 25 | 15 |
| | [cc/m² ·day · atm] | | | | | | |
| Layer | PO layer (D) | type | LDPE | LDPE | LDPE | LDPE | LDPE |
| structure | barrier layer (E) | type | EVOH-38 | EVOH-38 | EVOH-38 | PA6/66 | EVOH-38 |
| (Y) | density [g/cm³] | | 0.95 | 0.95 | 0.95 | 0.97 | 0.95 |
| | oxygen transmission rate | | 7.5 | 7.5 | 7.5 | 50 | 7.5 |
| | [cc/m² · day · atm] | | | | | | |
| density difference between the layer structure (X) | | | 0.43 | 0.43 | 0.43 | 0.41 | 0.06 |
| and the layer structure (Y)[g/cm³] | | | | | | | |
| Evaluation | interlayer adhesiveness | | A | C | D | A | A |
| of | (under high humidity condition) | | | | | | |
| characteristics | peelability of layer | peeling | 0 | 67 | 99 | 97 | 78 |
| | structure (X) and | percentage (%) | | | | | |
| | layer structure (Y) | evaluation | E | E | A | A | D |
| | separability of layer | separation | — | 99 | 99 | 99 | 50 |
| | structure (X) and | percentage (%) | | | | | |
| | layer structure (Y) | evaluation | — | A | A | A | D |

| | | | | | |
|---|---|---|---|---|---|
| oxygen barrier property | B | B | B | D | B |

### Example 19

A multilayer structure was produced in a similar manner to Example I except that the surface of the water-soluble layer (A) of the “laminate in which the water-soluble layer (A) was laminated on the layer structure (X)” was subjected to printing with an ink. The multilayer structure thus obtained was cut out into 100 regular tetragonal pieces of 1 cm×1 cm therefrom to give test pieces. The test pieces thus obtained were stirred in water having a temperature of 80° C. for 60 min and thereafter left to stand still for 5 min. When 100 films sedimented were collected, 98 films were transparent due to separation of printed ink, and the remaining two films were multilayer structures sedimented, without peeling, of the layer structure (X) and the layer structure (Y).

### Example 20

A multilayer structure was produced in a similar manner to Example 1, except that after the surface of the PET film (substrate layer (B)) was subjected to printing with an ink, the surface of the printed substrate layer (B) was coated with an anchor coating agent using a bar coater such that the average thickness after drying became 80 nm to produce the layer structure (X) provided with the adhesive layer (C). The multilayer structure thus obtained was cut out into 100 regular tetragonal pieces of 1 cm×1 cm therefrom to give test pieces. The test pieces thus obtained were stirred in water having a temperature of 80° C. for 60 min and thereafter left to stand still for 5 min. When 100 films sedimented were collected, 98 films exhibited peeling of the layer structure (X) and the layer structure (Y), whereas in two multilayer structures, peeling of the layer structure (X) and the layer structure (Y) failed. However, there were zero transparent films exhibiting separation of the printed ink.

From the results of Example 19 and Example 20, by subjecting the surface of the water-soluble layer (A) of the layer structure (X) to printing, a transparent substrate layer (B) can be obtained by washing with water while stirring as in Example 19, indicating facilitated recycling. On the other hand, in the case of subjecting the surface of the substrate layer (B) to printing as in Example 20, collecting transparent substrate layer (B) failed, indicating that there can be a case of recycling becoming difficult in such intended usages for which transparency is demanded, as PET is frequently used for intended usages for which transparency is demanded. Polyesters such as polyethylene terephthalate have high melting points, and are difficult to recycle by mixing with other material(s) commonly used as a packaging material; however, by using the present technique, recycling is enabled even with combinations of materials which involve difficulty in recycling.

### INDUSTRIAL APPLICABILITY

While the multilayer structure of the present invention exhibits a sufficient oxygen barrier property and interlayer adhesiveness as a packaging material under common usage conditions, the layer structure (X) and the layer structure (Y) can be each separated and collected after use as a packaging material, with superior peelability in the separation step. Accordingly, recycling suitability as a packaging material can be improved while inhibiting deterioration of performance and/or quality as the packaging material, thereby enabling contribution to realization of a recycling-oriented society.

1. A multilayer structure comprising a layer structure (X) and a layer structure (Y) which are laminated via a water-soluble layer (A), wherein
the layer structure (X) includes a substrate layer (B) comprising at least one selected from the group consisting of a thermoplastic resin and a metal,
the layer structure (Y) includes a polyolefin layer (D) or a paper layer,
a density difference (X-Y) between the layer structure (X) and the layer structure (Y) is 0.2 g/cm³ or more,
an oxygen transmission rate (OTR) of at least one of the layer structure (X) and the layer structure (Y) measured in accordance with JIS K7126-2 (equal pressure method; 2006) at 20° C. and 65% RH is 20 cc/(m²·day·atm) or less, and
the water-soluble layer (A) contains a hydroxyl group-containing resin (a1) and an alkali metal ion (a2), and a content of the alkali metal ion (a2) in the water-soluble layer (A) is 10 ppm or more and 2,000 ppm or less.

2. The multilayer structure according to claim 1, wherein a density of the layer structure (X) is 1.0 g/cm³ or more, and a density of the layer structure (Y) is 1.0 g/cm³ or less.

3. The multilayer structure according to claim 1, wherein the hydroxyl group-containing resin (a1) is a polyvinyl alcohol.

4. The multilayer structure according to claim 3, wherein a viscosity-average degree of polymerization of the polyvinyl alcohol is 400 or more and 2,000 or less.

5. The multilayer structure according to claim 3, wherein a degree of saponification of the polyvinyl alcohol is 70 mol % or more and 95 mol % or less.

6. The multilayer structure according to claim 3, wherein a sum of contents of a vinyl alcohol unit and a vinyl ester unit in total monomer units of the polyvinyl alcohol is 95 mol % or more.

7. The multilayer structure according to claim 1, wherein the water-soluble layer (A) further comprises a plasticizer (a3) which consists of at least one selected from the group consisting of glycerin, polyethylene glycol, polypropylene glycol, polyglycerin, mannitol, sorbitol, and pentaerythritol.

8. The multilayer structure according to claim 1, wherein the substrate layer (B) comprises a polyester resin as a principal component.

9. The multilayer structure according to claim 1, wherein the layer structure (X) comprises an adhesive layer (C) being in contact with the water-soluble layer (A).

10. The multilayer structure according to claim 1, wherein a ratio of a mass of the polyolefin layer (D) to a total mass of the layer structure (Y) is 0.90 or more.

11. The multilayer structure according to claim 1, wherein the layer structure (Y) comprises a barrier layer (E) comprising, as a principal component, at least one selected from the group consisting of a polyamide and an ethylene-vinyl alcohol copolymer.

12. The multilayer structure according to claim 11, wherein the barrier layer (E) comprises the ethylene-vinyl alcohol copolymer as a principal component.

13. The multilayer structure according to claim 1, wherein at least one of the layers is subjected to printing.

14. A method for separating a multilayer structure, the method comprising dissolving a part or all of the water-soluble layer (A) by bringing the multilayer structure according to claim 1 into contact with water (W) having a temperature of 20° C. to 95° C., wherein
in the dissolving, the layer structure (X) is sedimented and the layer structure (Y) is floated, in the water (W).

15. A method for recycling a multilayer structure, the method comprising independently melt molding each of the layer structure (X) and the layer structure (Y), each being collected by the method for separating a multilayer structure according to claim 14.
